(19) United States
(12) Patent Application Publication
(10) Pub. No.: US 2026/0254971 A1
(43) Pub. Date: Aug. 27, 2026

(54) ENCODING AND DECODING DATA ARRAYS

(71) Applicant: Arm Limited, Cambridge (GB)

(72) Inventors: HAKAN LARS-GORAN PERSSON, Arlöv (SE); JAKOB AXEL FRIES, Lund (SE); OLOF HENRIK UHRENDHOLT, Lomma (SE); BJORN FREDRIK WICTORIN, Helsingborg (SE)

(73) Assignee: Arm Limited, Cambridge (GB)

(21) Appl. No.: 19/064,296

(22) Filed: Feb. 26, 2025

(51) Int. Cl. H04N 19/146; H04N 19/176

(52) U.S. Cl. CPC H04N 19/146; H04N 19/176

(57) ABSTRACT

When encoding a data array in a lossless manner, the data array is encoded using a lossless encoding scheme, and using an auxiliary encoding scheme that can encode at least some data arrays in a lossless manner such that the original array of data elements can be reconstructed from the encoded data. The result of encoding the data array using the auxiliary encoding scheme is then used to determine whether to use a result of the encoding of the data array using the auxiliary encoding scheme for the output encoded data array or whether to use a result of the encoding of the data array using the lossless encoding scheme for the output encoded data array.

### BACKGROUND

The technology described herein relates to a method of and apparatus for encoding data, e.g. for storage in memory, in data processing systems, and in particular to methods and apparatus for compressing and storing image data such as texture or frame buffer data in graphics processing systems. Also described are a corresponding decoding method and apparatus.

Data processing systems often store generated image data within a frame buffer. The frame buffer typically contains a complete set of data for a frame (image), e.g. that is to be displayed, including, for example, colour values for each of the (e.g.) sampling positions within the frame. A suitable display driver is then able to read the contents in the frame buffer and use the image data stored therein to drive a display to display the desired frame (image).

The storage and access of image data in a frame buffer (the “frame data”) can place relatively high demands on the, e.g., storage and/or bandwidth resource of the data processing system (or conversely, e.g., lead to reduced performance when such demands are not met).

To reduce the burden imposed on a data processing system, it is therefore desirable to be able to store such frame buffer data in a “compressed” format. This is particularly desirable in data processing apparatus, e.g. portable devices, such as digital cameras, or mobile devices, such as phones, including such cameras, where processing resources and power may be relatively limited.

Similar considerations apply to various other instances where it is desired to reduce the amount of data needed for the storage and/or transmission of a certain piece of information. Another example, also in the context of graphics processing, would be when storing texture data, e.g. in the form of an array of texture elements (“texels”), each representing given texture data (such as colour luminance, etc.) that can then be mapped onto respective sampling positions of a render output being generated. Again, the storage and access of such texture data can place relatively high storage and/or bandwidth requirements on a data (graphics) processing system.

Accordingly it is common to encode arrays of data elements, such as arrays of image data values, so as to compress the data in order to reduce bandwidth and memory consumption. To this end, various data compression schemes have been developed.

Some data compression schemes encode the data in a lossless manner such that the original array of data elements can be perfectly reconstructed from the encoded data.

However, for some applications it may be acceptable to lose some output fidelity, e.g. in order to achieve a greater reduction in the size of the compressed data, and/or to be able to guarantee a given bandwidth (bit rate). Accordingly, other data compression schemes may encode data in a “lossy” manner, such that it cannot be guaranteed that the original array of data elements can be perfectly reconstructed from the encoded data.

The Applicants believe that there remains scope for improved arrangements for encoding data.

### BRIEF DESCRIPTION OF THE DRAWINGS

Various embodiments of the technology described herein described herein will now be described by way of example only and with reference to the accompanying drawings, in which:

FIG. 1 shows schematically an example of a data processing system within which embodiments of the technology described herein may be implemented;

FIG. 2 shows schematically an encoder according to an embodiment;

FIG. 3 shows an exemplary overall data array to be encoded;

FIG. 4 is a flowchart schematically illustrating a lossless encoding scheme according to an embodiment;

FIG. 5 is a flowchart schematically illustrating an auxiliary encoding scheme according to an embodiment;

FIG. 6 is a flowchart schematically illustrating the encoding of a data array according to an embodiment;

FIG. 7 is a flowchart schematically illustrating the encoding of a data array according to another embodiment;

FIG. 8 shows schematically a decoder according to an embodiment;

FIG. 9 is a flowchart schematically illustrating the decoding of an encoded data array according to an embodiment; and

FIG. 10 shows schematically an overall encoding and decoding sequence according to an embodiment.

Like reference numerals represent like elements in the drawings, as appropriate.

### DETAILED DESCRIPTION

A first embodiment of the technology described herein comprises a method of operating a data encoder that is capable of encoding arrays of data elements using two different encoding schemes, including a lossless encoding scheme that will encode data arrays in a lossless manner such that the original array of data elements can be reconstructed from the encoded data, and an auxiliary encoding scheme that can encode at least some data arrays in a lossless manner such that the original array of data elements can be reconstructed from the encoded data, the method comprising:
when it is desired to encode a data array in a lossless manner:
encoding the data array using the lossless encoding scheme; and
encoding the data array using the auxiliary encoding scheme; and
determining whether to use a result of the encoding of the data array using the auxiliary encoding scheme for the output encoded data array based on a result of encoding the data array using the auxiliary encoding scheme.

A second embodiment of the technology described herein comprises an apparatus for encoding data (a data encoder), comprising:
an encoding circuit configured to encode an array of data elements using a lossless encoding scheme that will encode data arrays in a lossless manner such that the original array of data elements can be reconstructed from the encoded data; and
an auxiliary encoding circuit configured to encode an array of data elements using an encoding scheme that can encode at least some data arrays in a lossless manner such that the original array of data elements can be reconstructed from the encoded data;
the apparatus (encoder) further comprising:
a processing circuit configured to, when it is desired to encode a data array in a lossless manner:
cause the data array to be encoded using the lossless encoding scheme, and to be encoded using the auxiliary encoding scheme;
and to:
determine whether to use a result of the encoding of the data array using the auxiliary encoding scheme for the output encoded data array based on a result of encoding the data array using the auxiliary encoding scheme.

The technology described herein relates to encoding data arrays in encoding systems (encoders) that support both a lossless encoding (compression) scheme (which accordingly will encode a data array in a lossless manner such that the original array of data elements can be reconstructed from the encoded data), and an auxiliary encoding (compression) scheme (that will encode at least some data arrays in a lossless manner such that the original array of data elements can be reconstructed from the encoded data).

In the technology described herein, when it is desired to encode a data array in a lossless manner, rather than simply using the (supported) lossless encoding (compression) scheme to do that, the data array is also encoded using the auxiliary encoding (compression) scheme, and then, depending upon the result of encoding the data array using the auxiliary encoding scheme, it is determined whether to use the output of the auxiliary encoding scheme (i.e. the encoded data array as produced by encoding the original data array using the auxiliary encoding scheme) for the output encoded data array or not. (In the case where it is determined not to use the output of the auxiliary encoding scheme for the output encoded data array, then as will be discussed further below, the encoded output of the lossless encoding scheme, or, in an embodiment, the encoded output of the lossless encoding scheme or the original data array itself, should be, and is in an embodiment, used for the output encoded data array).

The Applicants have recognised in this regard, that while using an inherently lossless encoding scheme may guarantee that a data array can be encoded in a lossless manner, it may be the case that at least for some data arrays, the data array can be losslessly encoded more efficiently using a different encoding scheme (that is able to encode at least some data arrays in a lossless manner).

The technology described herein exploits this, by, when it is desired to encode a data array in a lossless manner, not simply encoding the array using one inherently lossless encoding scheme, but also encoding the data array using an “auxiliary” encoding scheme that can encode at least some data arrays in a lossless manner, to, in particular, and in an embodiment, determine whether that provides a better “lossless” encoding of the data array. By also using the “main” lossless encoding scheme to encode the data array, it can be guaranteed that in any event a lossless encoded version of any given data array can be provided.

The technology described herein can therefore provide improvements, for example, in terms of memory resource and bandwidth, when losslessly encoding data arrays.

The data array that is to be encoded in the technology described herein can be any suitable and desired data array. It should comprise a plurality of data elements (entries), each occupying different positions in the array. It may comprise an overall data array to be encoded (such as an image to be encoded) or part of an overall data array to be encoded, such as a respective block of overall data array that is to be encoded in a block-by-block manner.

The data array is in an embodiment (in an embodiment represents) all or part of an image. In one embodiment the data array is all or part of a graphics texture. In another embodiment the data array is all or part of a frame (image), e.g. for display.

The technology described herein may also be used, for example, in image signal processing (in image signal processors) and video encoding and decoding (video encoders and decoders). It may also be used for non-image or graphics data, such as for data arrays representing other types of data.

The data array being encoded could comprise the entirety of an overall data array, and in one embodiment, that is the case. In this case, the entire data array would be encoded using the lossless encoding scheme and using the auxiliary encoding scheme, and it then determined whether to use the output encoded (overall) data array from the auxiliary encoding scheme as the output encoded data array or not.

In an embodiment, the data array being encoded is a part (but not all) of an overall data array (e.g. and in an embodiment, that is being encoded on a block-by-block basis, i.e. in which the overall data array to be encoded is divided into plural blocks to be (and that are) encoded on a block-by-block basis).

Thus, in an embodiment, the data array that is being encoded comprises a (respective) block of an overall data array that is being encoded on a block-by-block basis. In this case, each block of the overall data array is in an embodiment encoded in the manner of the technology described herein, i.e. using the lossless and auxiliary encoding schemes, and it is then determined for the respective block whether to use the result of encoding the block using the auxiliary encoding scheme as the output encoded version of that data block or not. Correspondingly, in this case it will be determined on a block-by-block basis whether to use the lossless encoding scheme or the auxiliary encoding scheme for encoding a (and each) block of the overall data array.

When encoding an overall data array in the manner of the technology described herein on a block-by-block basis, in an embodiment the same size and configuration of blocks is used for both the lossless and auxiliary encoding schemes (i.e. the overall data array is divided into a single set of blocks, with those blocks then respectively being encoded using both the lossless and auxiliary encoding schemes, with the respective “encoded” output for a given block of the overall data array then being selected accordingly).

In this case, it may be (and is in an embodiment possible for it to be) the case that different blocks of the same overall data array will be encoded using different ones of the lossless and auxiliary encoding schemes. Correspondingly, all the blocks that an overall data array is divided into do not all need to be encoded using the same encoding scheme.

Thus, for a given overall data array that is encoded in the manner of the technology described herein on a block-by-block basis, the output encoded version of the overall data array (in an embodiment) may accordingly comprise zero or more blocks that are encoded using the lossless encoding scheme, zero or more blocks that are encoded using the auxiliary encoding scheme (and in embodiments, zero or more blocks that are in their original form (i.e. “uncompressed”)).

Thus, in an embodiment, the data array that is being encoded comprises a block of a plurality of blocks that an overall data array is divided into for encoding purposes.

Correspondingly, in an embodiment, the method of the technology described herein comprises:
for each block of a plurality of blocks that an overall data array is divided into for encoding purposes:
encoding the block using the lossless encoding scheme; and
encoding the block using the auxiliary encoding scheme; and
determining whether to use a result of the encoding of the block using the auxiliary encoding scheme for the output encoded block of the overall data array based on a result of encoding the block using the auxiliary encoding scheme.

Correspondingly, in an embodiment, the processing circuit configured to, when it is desired to encode a data array in a lossless manner:
cause the data array to be encoded using the lossless encoding scheme, and to be encoded using the auxiliary encoding scheme;
and to:
determine whether to use a result of the encoding of the data array using the auxiliary encoding scheme for the output encoded data array based on a result of encoding the data array using the auxiliary encoding scheme;
is configured to:
cause a (and in an embodiment each) respective block of a plurality of blocks that an overall data array is divided into for encoding purposes to be encoded using the lossless encoding scheme, and to be encoded using the auxiliary encoding scheme;
and to:
determine for a (and each) respective block of an overall data array whether to use the result of the encoding of the block using the auxiliary encoding scheme for the output encoded block of the overall data array based on a result of encoding the block using the auxiliary encoding scheme.

The blocks that a data array (e.g. texture) to be encoded is divided into for encoding purposes can take any suitable and desired form. Each block should, and in an embodiment does, comprise a sub-set of the data elements (positions) in the overall array, i.e. correspond to a particular region (e.g. area or volume) of the overall array. In an embodiment the overall array is divided into non-overlapping and regularly sized and shaped, in an embodiment rectangular (and in an embodiment square) blocks.

In an embodiment, the number of data elements (e.g. pixels) per block is between 16 and 64, and the shape of the blocks is between square blocks and two data elements (pixels) tall.

The blocks in an embodiment correspond to a block size that will otherwise be used in the data processing system in question. Thus, in the case of a tile-based graphics processing system and pipeline, the blocks in an embodiment correspond to (have the same size and configuration as) the tiles that the rendering process of the graphics processing system operate on.

In an embodiment, a number of (e.g. 16) encoded blocks are packed together into a compressed coding unit, with each coding unit having a header that specifies the size of the encoded data for each block (thus enabling direct access to the encoded data for an individual block). The number of blocks that are packed together into a coding unit may, e.g., depend on the data element (pixel) format and software choice.

Other arrangements would, of course, be possible.

The lossless encoding scheme that is supported by the encoder and used in the technology described herein can be any suitable and desired lossless data encoding scheme, i.e. that can encode a data array in a lossless manner such that the original array of data elements can be (perfectly) reconstructed from the encoded data.

As discussed above, the lossless encoding scheme in an embodiment encodes an overall data array in a block-based manner (uses a block-based encoding scheme). Thus, the lossless encoding scheme in an embodiment encodes respective blocks of a data array (in a lossless manner).

In an embodiment, the lossless encoding scheme is as described in one or more of the Applicant's U.S. Pat. Nos. 8,542,939 B2, 9,014,496 B2, 8,990,518 B2, 9,116,790 B2, and 11,023,132 B2, the contents of which are incorporated herein by reference in their entirety.

Other forms of lossless encoding scheme could be used if desired.

In an embodiment, the lossless encoding scheme can output an unencoded (uncompressed) version of a data array (e.g. block of an overall data array, as appropriate) that is being encoded (i.e. the data array (e.g. block) in its original, input, form), for example, and in an embodiment, (at least), in the case where encoding the data array using the lossless encoding scheme results in a larger output data size than the original, input data to be encoded (and in an embodiment in the case where encoding the data array using the lossless encoding scheme results in an output data size that is equal to or larger than the original, input data to be encoded).

Thus, in an embodiment, encoding a data array using the lossless encoding scheme comprises determining whether the encoded version of the data array generated when applying the lossless encoding scheme to the input data array results in a data output that is larger than the input data array itself (and in an embodiment determining whether the encoded version of the data array generated when applying the lossless encoding scheme to the input data array results in a data output that is larger than or equal to the input data array itself), and when the encoding of an input data array using the lossless encoding scheme results in an output data array that is larger than (and in an embodiment that is equal to or larger than) the input data array, providing the input data array in its input form as the output of the lossless encoding scheme for the data array (to be used as the “encoded” lossless representation of the input data array).

In an embodiment, the lossless encoding scheme is configured to output an unencoded (uncompressed) version of a block of an overall data array that is being encoded in the case where the encoding of the block using the lossless encoding scheme results in a larger output size than a particular, in an embodiment selected, in an embodiment predetermined, threshold (maximum) output data size.

Thus, in an embodiment, encoding a data array (e.g. a block of an overall data array) using the lossless encoding scheme comprises determining whether the encoded version of the data array generated when applying the lossless encoding scheme to the input data array results in a data output that is larger than a threshold data size, and when the encoding of an input data array using the lossless encoding scheme results in an output data array that is larger than the threshold data size, providing the input data array in its input form as the output of the lossless encoding scheme for the data array (to be used as the “encoded” lossless representation of the input data array).

In this case, the particular, maximum permitted threshold output data size above which an unencoded (uncompressed) version of a block of an overall data array will be output is in an embodiment set to be a particular, in an embodiment selected, and in an embodiment predetermined, margin smaller than the data size of the uncompressed version of the data block that is to be encoded (i.e. smaller than the original, input data to be encoded).

This margin is in an embodiment set to one byte (i.e. such that the maximum permitted threshold output data size above which an uncoded (uncompressed) version of a block of an overall data array will be output is one byte smaller than the size of the original (uncompressed) input data block).

Thus, for example, in the case where the input data array is an image having an R8G8B8 pixel format, and the input data block to be encoded is a 4×4 pixel block, the uncompressed size of the input data block will be 48 bytes. The threshold above which the input data block would be output in an unencoded (uncompressed) form would, in embodiments at least, then be set to 47 bytes (i.e. such that if the encoded version of the input data block has a size of 47 bytes or fewer, the encoded version of the data block would be output as the output of the lossless encoding scheme, but if the losslessly encoded version of the input data block is greater than 47 bytes, the input data block in its original, unencoded (uncompressed) form would be output as the output of the lossless encoding scheme).

As will be discussed further below, this can simplify and facilitate the handling of “encoded” data blocks in the decoder in the case where the lossless encoding scheme would result in an encoded block size that is close to or greater than the uncompressed data size.

In an embodiment, a different threshold encoded data block size for determining whether or not simply to output the input data block in its input, uncompressed form is used for different input data array formats and block sizes (in terms of the number of data elements in the block) (as different input data array formats and block sizes will have different “uncompressed” data sizes). Accordingly, there may be a plurality of “uncompressed” output thresholds, with the threshold to be used for any given data array being selected and set according to the format and size (in terms of the number of data elements (e.g. pixels)) of the input data array.

The auxiliary encoding scheme that is supported and used in the technology described herein can be any suitable and desired encoding scheme that is capable of encoding input data arrays in a lossless manner, at least in certain circumstances.

The auxiliary encoding scheme should be, and is in an embodiment, a different encoding scheme to the lossless encoding scheme, i.e. that will operate to encode data arrays in a different manner to the lossless encoding scheme (but that is still capable of encoding at least some input data arrays in a lossless manner).

The auxiliary encoding scheme is again in an embodiment a block-based encoding scheme, which operates on respective blocks of an overall input data array, for example, and in an embodiment, to encode respective blocks of an overall input data array on a block-by-block basis.

In an embodiment, the auxiliary encoding scheme is configured and operable such that it can encode at least some input data arrays in a lossless manner, but it is not guaranteed to encode all data arrays in a lossless manner.

This can be achieved in any suitable and desired manner. In an embodiment, the auxiliary encoding scheme is configured such that it will either succeed in encoding an input data array in a lossless manner or it will fail to do so. Thus, in an embodiment, the auxiliary encoding scheme is configured and operable to attempt to encode an input data array in a lossless manner, and will either succeed in doing so, or will fail in doing so.

In an embodiment, the auxiliary encoding scheme, when it fails to encode an input data array in a lossless manner, provides an output indicative of that (to that effect) (rather than providing an output encoded array).

In an embodiment, the auxiliary encoding scheme is configured to operate, and operates, in this manner, by there being a maximum, permitted, threshold data size that the auxiliary encoding scheme encodes to, and when the auxiliary encoding scheme is able to encode an input data array in a lossless manner within the threshold maximum data size, it succeeds in encoding an input data array in a lossless manner, but when it is unable to do that, it fails to encode the data array in a lossless manner.

Thus, in an embodiment, the auxiliary encoding scheme is an encoding scheme that will encode a input data array in a lossless manner but that operates to (and is configured to) “fail” the lossless encoding of a data array if (when) a particular, in an embodiment selected, in an embodiment predetermined, maximum encoded data size is exceeded (i.e. it will encode an input data array in a lossless manner but subject to a maximum permitted encoded data size).

Thus, in an embodiment, the auxiliary encoding scheme is an encoding scheme that is configured to encode a block of an overall input data array in a lossless manner, but subject to a maximum permitted encoded data size for the block (and in an embodiment for each block) of the overall input data array, i.e. such that when a block of an overall data array can be fully encoded in a lossless manner in (without exceeding) the permitted maximum data encoded data size, the block will be encoded in a lossless manner, but when the block cannot be encoded in the lossless manner in (without exceeding) the permitted maximum data size, the auxiliary encoding scheme will fail to encode the block in a lossless manner.

The maximum permitted data size that the auxiliary encoding scheme uses can be set and selected in any suitable and desired manner, and can be any suitable and desired permitted maximum data size.

In an embodiment, the maximum permitted data size used (set) for the auxiliary encoding scheme is based on the uncompressed (unencoded), input data size for a particular, in an embodiment selected, in an embodiment predetermined, data array size (in terms of the number of data elements) and data (e.g. pixel) format.

In this case, the permitted fixed maximum data size for the auxiliary encoding scheme could be set to be equal to the corresponding uncompressed data array size.

In an embodiment, the permitted fixed maximum data size used for the auxiliary encoding scheme is set at a particular, in an embodiment selected, and in an embodiment predetermined, margin smaller than the corresponding uncompressed data array (data) size (i.e. smaller than the uncompressed input data array size). This will then have the effect that the auxiliary encoding scheme should and will only be able to encode an input data array in a lossless manner in the case where the auxiliary encoding scheme is able to do that within an output encoded data array size that is smaller than a given input, uncompressed data array size. This can then, for example, simplify the decoding operation in the case where the lossless encoding scheme will or is likely to output an unencoded (uncompressed) input data array as its encoding result.

The margin is in an embodiment set to be at least one byte, and in an embodiment at least two bytes, smaller than the size of the original (uncompressed) input data array that is being considered.

In an embodiment, the margin that is used for the permitted maximum data size used for the auxiliary encoding scheme is set to be larger than the margin that is used to determine whether the lossless encoding scheme should output an input data array in its original, unencoded (uncompressed) form. In other words, the threshold output data size above which the lossless encoding scheme will output an unencoded (uncompressed) version of the input data array is in an embodiment greater than the permitted maximum data size for the auxiliary encoding scheme (that the auxiliary encoding scheme must not exceed in order to succeed at losslessly encoding an input data array).

In an embodiment, this margin is set to be two bytes smaller than the size of the original (uncompressed) input data array that is being considered.

It would be possible in this regard to have a different permitted maximum data size for the auxiliary encoding of an input data array for each different input data array format and/or block size (in terms of the number of data elements) that the auxiliary encoding scheme supports (and in one embodiment that is what is done).

In an embodiment, there is only one, single, permitted maximum (encoded) data size used for the auxiliary encoding scheme (and that is used irrespective of the input block size and data format of the data array that is actually to be encoded).

This may, for example, simplify the determination at the decoder of whether the auxiliary encoding scheme could have been used to encode an encoded data array (e.g. block).

In an embodiment where a single permitted maximum data size is used for this purpose, that single permitted maximum data size is in an embodiment based on the smallest uncompressed data block size for the data array formats and data block sizes that the auxiliary encoding scheme supports, and is in an embodiment set to a particular, in an embodiment selected, and in an embodiment predetermined, margin (and in an embodiment a margin of at least 1, and in an embodiment of at least 2, bytes) smaller than the smallest uncompressed data block size for the data array formats and data block sizes that the auxiliary encoding scheme supports.

In an embodiment, the (single) permitted maximum data size that if exceeded means that the auxiliary encoding scheme fails to encode an input array (e.g. block) losslessly is a data size that is 2 bytes smaller than the smallest uncompressed data block size for the data array formats and data block sizes that the auxiliary encoding scheme supports.

Thus, for example, in the case where the smallest uncompressed data block size that the auxiliary encoding scheme supports is a 4×4 pixel block having an R8G8B8 pixel format, the (single) permitted maximum data size that is used for the auxiliary encoding scheme is in an embodiment set to 46 bytes.

In an embodiment, the auxiliary encoding scheme operates to encode an input data array (e.g. block) to a fixed sized data packet and is further operable to and configured to generate two streams of encoded (compressed) data, with one stream being stored starting from the beginning (start) of the output encoded data packet growing towards the end of the output encoded data packet, and the other encoded data stream being stored starting at the end (the other end) of the output encoded data packet and growing towards the beginning (start) of the encoded data packet. Generating two streams of encoded data in this manner allows parsing of more data elements per clock cycle, for example, and can reduce the pipeline length of the auxiliary encoding (and decoding) hardware.

In this case, it can then be determined whether the auxiliary encoding scheme was able to encode the input data array (e.g. block) (in a lossless manner) within the permitted maximum “encoding” size by determining whether the two streams of encoded data meet (overlap) in the encoded data packet or not.

In an embodiment, the auxiliary encoding scheme is based on, and operates (at least in part) in accordance with, a lossy encoding scheme (which is an encoding scheme that is not guaranteed to encode a data array such that the original array of data encoding elements can be perfectly reconstructed from the encoded data).

In this case, the auxiliary encoding scheme should accordingly be, and is in an embodiment, a “modified” version of the lossy encoding scheme, and may, for example, and in an embodiment, provide as an encoded data array a similar output to what the lossy encoding scheme would provide, but with certain differences, such as, for example, and in an embodiment, not providing all the information (e.g. the meta information) relating to the encoding that the lossy encoding scheme would output.

In an embodiment, the data encoder/encoding process is also capable of encoding arrays of data elements using a lossy encoding scheme that is not guaranteed to encode a data array such that the original array of data elements can be perfectly reconstructed from the encoded data (and includes a corresponding encoding circuit that is configured to encode an array of data elements using a lossy encoding scheme that is not guaranteed to encode a data array such that the original array of data elements can be perfectly reconstructed from the encoded data), and the auxiliary encoder/encoding process is based on, and uses at least aspects of, that lossy encoding scheme to (losslessly) encode data arrays in the operation of the technology described herein.

Thus, in an embodiment, the encoding process/encoder supports both the auxiliary (lossless) encoding scheme that is used in the technology described herein, and a “corresponding” lossy encoding scheme, and the encoder can be controlled (triggered) to encode a data array either using the auxiliary, lossless encoding scheme, or the lossy encoding scheme, as desired.

The encoding process/encoder is in an embodiment correspondingly controllable to either encode a data array in a lossy manner using the lossy encoding scheme, or to encode a data array in a lossless manner in the manner of the technology described herein.

In this case, the lossy encoding scheme that the auxiliary encoding scheme of the technology described herein is based on (and that is in an embodiment also supported) is in an embodiment a scheme that will operate to discard data of an encoded representation of an input data array, and/or truncate (stop) encoding of an input data array, when a desired maximum encoded data size is reached (such that the encoding scheme is lossy).

In an embodiment, the lossy encoding scheme that the auxiliary encoding scheme is based on (and that is in an embodiment also supported) is an encoding scheme that is able to guarantee a given bandwidth (bit rate). In an embodiment, the lossy encoding scheme is an encoding scheme that encodes to fixed-size (encoded) data packets. (In this case, the encoding into the fixed-size data packets is inherently “lossy”, since once a fixed-size data packet is full, any remaining bits that are then not included into the data packet are therefore effectively discarded, such that the information associated with the discarded bits is correspondingly lost.)

In an embodiment, the auxiliary encoding scheme (and the corresponding lossy encoding scheme, if supported) encodes a data array by first performing a frequency domain transform, and then performing bit plane coding of the frequency domain coefficients. This may be particularly suitable where the data array is image data.

Thus, in one particularly embodiment, the auxiliary encoding scheme operates to (and is configured to) encode a data array, such as a block of image data, or the like, by first applying a frequency transform operation to the array of data elements to transform the spatial representation of the data array into the frequency domain. The frequency domain coefficients can be (and in an embodiment are) stored using a sign-magnitude format, i.e. wherein a single bit is used for indicating the sign value (e.g. “1” for positive and “0” for negative, or vice versa), and wherein the magnitude is the absolute value of the coefficient (and so the most significant bit is also the highest non-zero bit). Bit plane coding is in an embodiment then performed on the frequency domain coefficients to decompose the (absolute) magnitude values for the frequency domain coefficients into a set of bit plane arrays containing the respective (binary) bit values at each bit position for each of the frequency domain coefficients. The bit plane represented data is in an embodiment then encoded by packing the bits from the most significant (top) bit plane downwards (in an embodiment) into a fixed size data packet until the data packet is full).

In an embodiment, the information within each bit plane array is encoded in a context-dependent manner wherein the bit plane information is encoded based on the information in previous bit planes (layers) in the bit plane sequence. In this way, the information can be encoded in a particularly efficient manner.

In an embodiment, in order to encode the bit plane information, the locations of the coefficients appearing in each bit plane are encoded recursively, by subdividing the bit plane array into respective sections (e.g. quadrants), indicating which section (quadrant) has a newly “active” frequency domain coefficient in that bit plane (i.e. a frequency domain coefficient for which its first non-zero bit value in the bit plane sequence appears in that bit plane), and then for any section that includes a newly active frequency domain coefficient in that bit plane, as well as for any sections, or subsections, indicated as being (newly) active during the encoding of a previous (higher) bit plane in the bit plane sequence, subdividing those sections into further subsections and indicating which of these subsection(s) include any newly active coefficients in that bit plane, and so on, as necessary, down to the locations of the individual frequency domain coefficients (i.e. the positions of the individual coefficients in the bit plane array) within the bit plane in question.

Also, the encoding of each successive bit plane in an embodiment encodes (indicates) the locations of the newly active sections relative to the preceding (higher) bit planes (levels) in the bit plane sequence, such that, for example, if a section has previously been indicated as including a newly active coefficient in a higher bit plane, for the next bit plane down the active “subsection” indication indicates which (if any) of the remaining (e.g. three, in the case of quadrants) “subsections” “newly” include an active coefficient (i.e. the first non-zero bit value in the bit plane sequence for a frequency domain coefficient).

Thus, when encoding a given bit plane, any “newly active” sections in that bit plane, i.e. those sections for which a non-zero bit value for at least one of the frequency domain coefficients included within that section appears for the first time in the bit plane sequence in that bit plane, are indicated. However, once a section has been made active (“activated”) in this way, it in an embodiment then remains “active” during the encoding of the next (lower) bit plane in the bit plane sequence (and all subsequent bit planes in the bit plane sequence). The locations of any newly active subsections, and ultimately the locations of any newly active coefficients, within each of the currently active sections (i.e. any sections that are newly active in the current bit plane, as well as any sections that were newly active in a previous bit plane in the bit plane sequence) can then be encoded during the encoding of a particular bit plane, in an embodiment using a variable length coding scheme.

The encoding of each bit plane is thus context-dependent on the previous bit plane (layer) in the bit plane sequence (and indicates changes relative to the previous bit plane).

Further data is in an embodiment then added, e.g. indicating the sign values for the newly active coefficients in the bit plane array being encoded and/or so-called “refinement bit values” for the bit plane array. (The “refinement bit values” represent the bit values in the bit plane in question for any coefficients for which the first non-zero bit value appeared in a previous bit plane in the bit plane sequence, i.e. the bit values for the less significant bit positions following the first non-zero bit position for those coefficients. The refinement bit values for a given bit plane array are thus the bit values in that bit plane array for the coefficients that were previously “activated” in a higher bit plane in the bit plane sequence). These sign and refinement bit values are in an embodiment raw coded (included as their actual values) in the data for the encoding of a bit plane array.

In this way, a code can be generated that indicates the locations (and in an embodiment also the sign and refinement bit values) for the bits in a bit plane (and in each of the bit planes).

Thus, in one particularly embodiment, the auxiliary encoding scheme encodes an array of data elements (in an embodiment representing a spatial distribution of values), by:
performing a frequency transform operation on the array of data elements to generate a corresponding set of frequency domain coefficients;
representing the set of frequency domain coefficients as a plurality of bit plane arrays, each bit plane array representing a particular bit position of the frequency domain coefficient values, wherein each bit plane array comprises an array of bits corresponding to the bit values of each of the frequency domain coefficients at the bit position that the bit plane array represents; and
encoding the set of frequency domain coefficients in a data packet having a fixed (data) size by encoding the bit plane arrays in a bit plane sequence working from the bit plane array representing the most significant bit downwards (in an embodiment until a maximum permitted data size is reached),
wherein each bit plane array is encoded by subdividing the bit plane array into respective sections and, subject to there being available space in the data packet, including in the data packet data indicating the locations of any sections in that bit plane array that for the first time in the bit plane sequence contain one or more coefficient(s) having a non-zero bit value, and then recursively subdividing into respective subsections any such newly active sections in the bit plane array as well as any sections for which the first non-zero bit value appeared in a previous bit plane array in the bit plane sequence, and including in the data packet data indicating the locations of any subsections for which the first non-zero bit value in the bit plane sequence appears in the bit plane array until the location(s) of the coefficient(s) for which the first non-zero bit value appears in the bit plane array are indicated.

In an embodiment, the lossy encoding scheme that the auxiliary encoding scheme is based on (and that is in an embodiment also supported) is as described in one or more of the Applicant's US Patent Publication No. US 2022-0014767 and the Applicant's U.S. Pat. No. 11,515,961, the contents of which are incorporated herein by reference in their entirety.

It would be possible for the auxiliary encoding scheme to be used to attempt to encode a data array in a lossless manner when lossless encoding of a data array is desired for any and all input data arrays (e.g. for any and all input data array formats) (and in one embodiment, that is what is done).

However, in an embodiment, the auxiliary encoding scheme is only used and attempted when it is desired to encode a data array in a lossless manner for particular, in an embodiment selected, in an embodiment predetermined, input data array formats (e.g., and in an embodiment, in terms of the data format for the data elements of the input data array).

The Applicants have recognised in this regard that the use and implementation of an auxiliary encoding scheme in the manner of the technology described herein may be simplified in the case where the possible data array formats that the auxiliary encoding scheme is used for is restricted. For example, there may be particular input data array formats that it may be particularly difficult or unlikely for the auxiliary encoding scheme to be able to encode in a lossless manner. The operation in the manner of the technology described herein can accordingly be (potentially) made more efficient, and/or the auxiliary encoding scheme/encoder made less complex, by configuring the operation so as to not use the auxiliary encoding scheme when such data array formats are encountered.

For example and in an embodiment, in the case of image data, such as frames or textures in a graphics processing system, there may be particular, and in an embodiment selected, and in an embodiment predetermined, input pixel formats that the auxiliary encoding scheme is not used for when it is desired to encode a data array in a lossless manner.

Thus, in an embodiment, the method of the technology described herein comprises (and the processing circuit is correspondingly configured to), when it is desired to encode a data array in a lossless manner:
(first) determining, based on the data format of the data array to be encoded in a lossless manner, whether to encode the data array using the lossless encoding scheme and using the auxiliary encoding scheme (in the manner of the technology described herein), or to only encode the data array using the lossless encoding scheme (and when it is determined to encode the data array using the lossless encoding scheme and using the auxiliary encoding scheme, then encoding the data array using the lossless encoding scheme and using the auxiliary encoding scheme (in the manner of the technology described herein), but when it is determined to only encode the data array using the lossless encoding scheme, only encoding the data array using the lossless encoding scheme).

Accordingly, in embodiments of the technology described herein at least, the lossless encoding scheme is used whenever it is desired to encode a data array in a lossless manner, but the auxiliary encoding scheme is only used to (attempt to) encode a data array in a lossless manner for data arrays having one of a particular, in an embodiment selected, in an embodiment predetermined, set of one or more, and in an embodiment plural, different data array formats.

Correspondingly, in an embodiment, the lossless encoding scheme is able to encode, and is used for encoding, data arrays having a data format in any one of a set of plural different data formats, but the auxiliary encoding scheme is only used to encode and when encoding data arrays having one of a subset of the data array formats that are supported by the lossless encoding scheme.

It can be determined whether to use the result of encoding a data array (e.g. block) using the auxiliary encoding scheme as the output encoded version of the data array in any suitable and desired manner.

In an embodiment, this determination comprises (at least) determining whether the auxiliary encoding scheme was able to encode the data array (e.g. block) in a lossless manner (whether the auxiliary encoding scheme (successfully) generated a lossless representation of the input data array or not).

In the event that the result of encoding the data array (e.g. block) using the auxiliary encoding scheme does not result (other than results) in a lossless representation of the input data array, then the result of encoding the input data array using the auxiliary encoding scheme should not be, and in an embodiment is not, used as the output encoded representation of the input data array.

Thus, in an embodiment, the method of the technology described herein comprises (and the processing circuit is correspondingly configured to) determining whether the encoding of the data array using the auxiliary encoding scheme achieves a lossless representation of the input data array; and
when the encoding the data array using the auxiliary encoding scheme does not result (other than results) in a lossless representation of the input data array, determining to not use (to other than use) the result of the encoding of the data array using the auxiliary encoding scheme for output encoded data array.

It can be determined whether the auxiliary encoding scheme was able to encode the input data in a lossless manner in any suitable and desired manner. This may, and in an embodiment does, depend upon how the auxiliary encoding scheme operates.

For example, in the case where the auxiliary encoding scheme operates by discarding data/truncating (stopping) encoding once a particular, e.g. maximum, encoded data size has been reached, it can be (and is in an embodiment) determined that the auxiliary encoding scheme has encoded the data array in a lossless manner based on whether any data of the encoded representation of the input data array generated by the auxiliary encoding scheme was discarded or not, and/or whether the auxiliary encoding was truncated (stopped) before it had finished.

In an embodiment, it is determined whether the auxiliary encoding scheme was able to encode the input data in a lossless manner by determining whether the auxiliary encoding scheme was able to (losslessly) encode the input data array within a (the) permitted maximum data size for that encoding (e.g., and in an embodiment, whether the auxiliary encoding scheme was able to completely encode the input data block in the permitted fixed data size for encoding the block in question (within the fixed size data packet for the encoded block) (whether any space remains in the fixed size data packet after completing encoding the data block using the auxiliary encoding scheme).

Thus, in an embodiment, determining whether the auxiliary encoding scheme was able to encode the input data array in a lossless manner comprises:
determining whether the auxiliary encoding scheme was able to (losslessly) encode the input data array within (without exceeding) a permitted maximum data size for encoding the array; and
when it is determined that the auxiliary encoding scheme was able to (losslessly) encode the input data array within (without exceeding) the permitted maximum data size for encoding the data array, determining that the auxiliary encoding scheme was able to encode the input data array in a lossless manner.

Correspondingly, in an embodiment, determining whether the auxiliary encoding scheme was able to encode the input data array in a lossless manner comprises:
determining whether the auxiliary encoding scheme was able to (losslessly) encode the input data array within (without exceeding) a permitted maximum data size for encoding the array; and
when it is determined that the auxiliary encoding scheme was not able to (was other than able to) (losslessly) encode the input data array within (without exceeding) the permitted maximum data size for encoding the data array, determining that the auxiliary encoding scheme was not able to (was other than able to) encode the input data array in a lossless manner.

In an embodiment (as discussed herein) the determination of whether the auxiliary encoding scheme is able to encode a data array in a lossless manner is based on a signal (indication) to that effect from the auxiliary encoder/encoding process, i.e. an indication as to whether the auxiliary encoding scheme failed to encode the input data in a lossless manner (e.g., and in an embodiment, was unable to (losslessly) encode the input data array within (without exceeding) a permitted maximum data size for that encoding).

In an embodiment, the (data) size of the (losslessly) encoded representation of the input data array (if any) that is generated by the auxiliary encoding scheme is also or instead, and in an embodiment also, used to determine whether to use the result of the encoding of the input data array generated using the auxiliary encoding scheme for the output encoded data array (in an embodiment (only) in the case where the auxiliary encoding scheme was able to encode the input data array in a lossless manner).

Thus, in an embodiment, the determining whether to use the encoded representation of the input data array generated by the auxiliary encoding scheme is based on one or both of, and in an embodiment both of, whether the auxiliary encoding scheme was able to encode the input data array in a lossless manner, and the size of an encoded representation of the input data array generated by the auxiliary encoding scheme.

In the case where the auxiliary encoding scheme encodes to a permitted, maximum (encoded) data size, then the size of the (losslessly) encoded representation of the input data array generated using the auxiliary encoding scheme that is considered in this regard, may, for example, simply comprise that permitted maximum encoded data size for the auxiliary encoding scheme (and in one embodiment this is the case).

In an embodiment, the size of the (losslessly) encoded representation of the input data array generated using the auxiliary encoding scheme that is considered in this regard is based on, and in an embodiment corresponds to, the actual size of the (losslessly) encoded representation of the input data array generated using the auxiliary encoding scheme (e.g., and in an embodiment, rounded up to the closest byte).

In this case, in the case where the auxiliary encoding scheme simply encodes an input data array subject to a permitted, maximum (encoded) data size, then the (actual) size of the (losslessly) encoded representation of the input data array initially generated using the auxiliary encoding scheme can simply be, and is in an embodiment, used as the size of the (losslessly) so-encoded representation of the input data array.

On the other hand, where the auxiliary encoding scheme initially (losslessly) encodes an input data array in an (initial) fixed size data packet, then the so-losslessly encoded representation of the input data array is in an embodiment (re)packed into a smaller block (packet) of encoded data representing the input data array losslessly when possible (i.e. so as to remove “redundant” space from the fixed sized data packet that the auxiliary encoding scheme initially encodes into), with the size of the (re)packed (losslessly) encoded array (e.g. block) then being used as the size of the (losslessly) encoded representation of the input data array generated using the auxiliary encoding scheme.

Thus, in an embodiment, the (lossless) encoded representation of the input data array (e.g. block) that is generated by the auxiliary encoding scheme is (re)packed into an (smaller) encoded data packet/block by removing some or all of any unused space from the fixed size encoded data packet/block that the auxiliary encoding scheme initially encoded the input array (e.g. block) into. In an embodiment this (re)packing of a losslessly encoded data array is done so as to (re)pack the losslessly encoded representation of the input data array into an appropriately aligned (e.g. and in an embodiment, byte-aligned) (smaller) encoded data packet/block and in an embodiment so as to remove as much unused (redundant) “space” from the initial encoded packet/block as possible.

Thus, in the case where the auxiliary encoding scheme operates to generate two streams of encoded data, one stored starting from the beginning of the encoded data block growing towards the end, and the other stored starting at the end of the encoded data block growing towards the beginning, in an embodiment the so-generated two encoded data streams will be (re)packed into a smaller block (and in an embodiment as small a byte-aligned block as possible).

(In this case, the auxiliary encoder/encoding scheme, if necessary, in an embodiment also provides (outputs) information allowing the positions of the forward and reverse bit streams in the “repacked” block to be determined (such as the position of the end of the forward bit stream and/or the position of the start of the reverse bit stream in the repacked packet), so that a decoder can determine that when decoding the repacked block (e.g., and in an embodiment, in the case where that cannot otherwise be determined, e.g. from the size of the compressed data.)

The size of the (re)packed lossless representation of the input data array (e.g. block) that was generated using the auxiliary encoding scheme is in an embodiment then used as the size of the lossless representation of the input data array that was generated using the auxiliary encoding scheme, e.g., and in an embodiment, for comparison with the size of the encoded representation of the input data array generated when using the lossless encoding scheme (etc.).

Other arrangements would, of course, be possible.

The size of the (losslessly) encoded data array generated by the auxiliary encoding scheme can be considered for the purpose of determining whether to use the result of the encoding of the input data array generated using the auxiliary encoding scheme for the output encoded data array in any suitable and desired manner.

For example, and in an embodiment, in the case where a permitted maximum encoded data size for the auxiliary encoding scheme is not (is other than) based on an appropriate uncompressed data block size (as discussed above), the losslessly encoded size of the losslessly encoded data array (e.g. block) generated by the auxiliary encoding scheme is in an embodiment then compared to a permitted maximum encoded data size for the auxiliary encoding scheme that is based on an (appropriate) uncompressed data block size, with the result of the encoding of the data array (e.g. block) using the auxiliary encoding scheme then not being (then other than being) selected and used as the encoded representation of the input data array when the encoded data array size is greater than that permitted maximum auxiliary encoding data size. This will then again have the effect of ensuring that encoded data arrays generated using the auxiliary encoding scheme are not used when the size of those arrays is close to the uncompressed data size for a given input data format/block size.

In an embodiment, it is considered whether the (data) size of the (losslessly) encoded representation of the input data array that is produced by the auxiliary encoding scheme is smaller than the (data) size of the (losslessly) encoded representation of the input data array when encoded using the lossless encoding scheme.

More in an embodiment, when the (data) size of the (lossless) encoded representation of the input data array generated using the auxiliary encoding scheme is greater than the (data) size of the representation of the input data array generated when using the lossless encoding scheme, the encoded representation of the input data array generated using the auxiliary encoding scheme is not (is other than) selected as the encoded representation of the input data array to use (to be output), but when the size of the (lossless) encoded representation of the input data array generated using the auxiliary encoding scheme is smaller than the size of the representation of the input data array generated when using the lossless encoding scheme, the encoded representation of the input data array generated using the auxiliary encoding scheme is selected (used) as the encoded representation of the input data array to use (to be output).

Thus, in an embodiment, determining whether to use a result of the encoding of the data array using the auxiliary encoding scheme for the output encoded data array based on a result of encoding the data array using the auxiliary encoding scheme comprises:
determining whether the auxiliary encoding scheme was able to encode the input data array in a lossless manner;
when the auxiliary encoding scheme was not able (was other than able) to encode the input data array in a lossless manner, determining not to (determining other than to) use a result of the encoding of the data array using the auxiliary encoding scheme for the output data array (and determining to use a result of the encoding of the data array using the lossless encoding scheme for the output data array);
when the auxiliary encoding scheme was able to encode the input data array in a lossless manner, comparing the size of the encoded representation of the input data array generated using the auxiliary encoding scheme to the size of the representation of the input data array generated when using the lossless encoding scheme; and
when the size of the encoded representation of the input data array generated using the auxiliary encoding scheme is smaller than the size of the representation of the input data array generated when using the lossless encoding scheme, determining to use a result of the encoding of the data array using the auxiliary encoding scheme for the output data array;
when it is determined that the size of the encoded representation of the input data array generated using the auxiliary encoding scheme is greater than the size of the representation of the input data array generated when using the lossless encoding scheme, determining not to (determining other than to) use a result of the encoding of the data array using the auxiliary encoding scheme for the output data array (and determining to use a result of the encoding of the data array using the lossless encoding scheme for the output data array).

As will be appreciated from the above, in the embodiments of the technology described herein at least, depending on the result of the auxiliary encoding for a data array, the “losslessly” encoded result/output for a given input data array (e.g. block) to be encoded will either be a losslessly encoded representation of the array that has been generated using the auxiliary encoding scheme, or a lossless representation of the array that has been generated using the lossless encoding scheme (which in an embodiment may be a lossless encoded representation of the array or simply the original array in an unencoded (uncompressed) form).

As will also be appreciated from the above, in the embodiments of the technology described herein at least, the determination of whether to use the result of the auxiliary encoding scheme for a data array will be based on whether the auxiliary encoding scheme was able to encode the array in a lossless manner and (potentially) the (data) size of the losslessly encoded array that the auxiliary encoding scheme generated.

Thus, in an embodiment, the auxiliary encoding scheme (the auxiliary encoder) is operable to and configured to, when (attempting to) losslessly encode a data array, provide as an output an indication of whether the auxiliary encoding scheme was able to encode the input data array in a lossless manner or not, and, when it was able to encode the input data array in a lossless manner, an indication of the (data) size of the so-generated encoded representation of the input data array. This information can be, and is in an embodiment, then used to determine whether to use a result of the encoding of the data array using the auxiliary encoding scheme for the output encoded data array.

As discussed above, in the case where the auxiliary encoding scheme generates “forward” and “reverse” bit streams and repacks those bit streams when it was able to encode an input data array losslessly, the auxiliary encoding scheme (the auxiliary encoder) is in an embodiment also operable to and configured to, if necessary, provide (output) information allowing the positions of the forward and reverse bit streams in the “repacked” encoded data to be determined (e.g., and in an embodiment, in the case where that cannot otherwise be determined from other information, such as the size of the encoded (compressed) data).

Correspondingly, in an embodiment, the lossless encoding scheme (the lossless encoder) is operable to and configured to, when losslessly encoding a data array, provide as an output an indication of the (data) size of the so-generated representation of the input data array. This information can be, and is in an embodiment, then used (where necessary) to determine whether to use a result of the encoding of the data array using the auxiliary encoding scheme for the output encoded data array or not.

(The size of the representation of the input data array generated by the lossless encoding scheme can also be, and is in an embodiment also, used by a decoder to determine whether that representation is an encoded version of the input data array or simply the input data array in an unencoded (uncompressed) form.)

The Applicants have recognised that where, as in the technology described herein, a losslessly encoded data array may in fact be encoded by one of two different encoding schemes (namely an auxiliary encoding scheme and a lossless encoding scheme), then the encoding scheme that has been used should be, and is in an embodiment, able to be determined by a decoder to allow the decoder to determine which corresponding decoding scheme to use when decoding the encoded data array.

The encoder/encoding process accordingly in an embodiment provides, at least in some circumstances, an indication of the encoding scheme that has been used for an encoded representation of a data array for (to) a decoder/decoding process to use. This can be done in any suitable and desired manner.

In an embodiment, an indication of the encoding scheme that has been used (where provided) is provided in (included in) the encoded representation of a data array itself. In an embodiment, the last (final) bit in an encoded (representation of a) data array (e.g. block) is used to indicate to the decoder (and used by a decoder to select between) which of the auxiliary and lossless encoding schemes has been used for the data array in question.

In an embodiment, the lossless encoding scheme is configured to (always) set any unused bits after the encoded (compressed) data (e.g., and in an embodiment up to the next byte boundary) to the same particular, in an embodiment selected, in an embodiment predetermined, bit value, such as, and in an embodiment, to zero (which value, e.g. 0, will then be used to indicate and taken as an indicator that the lossless compression scheme has been used).

(The lossless encoding scheme correspondingly in an embodiment has (operates to generate (output)) a single data stream starting at the beginning of the encoded (compressed) data.)

The auxiliary encoding scheme is correspondingly in an embodiment configured to, and operates to always add a bit with the other value (e.g., and in an embodiment, a value of one) at the end of a (and each) encoded data array that it generates.

Thus, in an embodiment, when encoding a data array using the auxiliary encoding scheme in the manner of the technology described herein, a bit with a (different) particular, in an embodiment selected, in an embodiment predetermined value (such as, and in an embodiment, 1), is included at the end of the encoded representation of the input data array that is produced by the auxiliary encoding scheme.

A decoder can then determine from the value of the bit at the end of the encoded data array that it is decoding whether the lossless encoding scheme or the auxiliary encoding scheme has been used for the array in question.

This arrangement will then allow a decoder to select between the auxiliary and lossless encoding schemes when decoding without the need to add a significant number of bits to the encoded data to indicate which of the encoding schemes has been used to the decoder (or to have to otherwise indicate that to the decoder).

The Applicants have recognised in this regard that it could be the case that the lossless encoding scheme encodes an input data array (e.g. block) to a byte-boundary, with the last bit in the final byte for the encoded data being other than the particular value (e.g. 0) that indicates that the lossless encoding scheme has been used. In this case, a further byte that is padded with the appropriate bit value (e.g., and in an embodiment 0) is in an embodiment added to the encoded data array generated by the lossless encoding scheme, so that the encoded representation of the data array will have the correct final bit value for indicating that the array (e.g. block) has been encoded using the lossless encoding scheme.

Thus, in an embodiment, when the lossless encoding scheme produces as its encoding result an encoded representation of an input data array, it is checked whether the last bit in the encoded representation of the input array generated by the lossless encoding scheme has a particular, in an embodiment selected, in an embodiment predetermined, value (such as, and in an embodiment, 0), and when the last bit does not have (when it other than has) the particular value, an additional byte is added at the end of the encoded representation of the input data array (to the encoded data array) that is padded with bits having the particular value (e.g., and in an embodiment, 0).

It would be possible to always, where necessary, add a further byte that is padded with the appropriate bit value (e.g., and in an embodiment, 0) to an encoded representation of an input array generated by the lossless encoding scheme whenever the last bit in the final byte is not the particular value that indicates the lossless encoding has been used (and in one embodiment, this is what is done).

In an embodiment, such padding in the case where the last bit in the encoded representation of input array generated by the lossless encoding scheme does not have (other than has) the particular value that indicates the lossless encoding scheme has been used is only done in the case where the encoded representation of the input array generated by the lossless encoding scheme is less than or equal to (does not exceed), a particular, in an embodiment selected, and in an embodiment predetermined, threshold size. In other words, when the encoded representation of the input array generated by the lossless encoding scheme is greater than the “padding” threshold size, an additional byte that is padded with bits having the particular value will not be (and is not) added at the end of the encoded representation of the input data array, even if the last bit of the encoded representation of the input data array does not end in the particular value that indicates that the lossless encoding scheme has been used.

In this case, the threshold size above which padding is not performed can be set to any suitable and desired threshold encoded data size. In an embodiment, the “adding” threshold size is set to be equal to the maximum permitted size that the auxiliary encoding scheme encodes to (is not allowed to exceed).

Thus, in the case where, as discussed above, the auxiliary encoding scheme encodes to a maximum permitted data size of 46 bytes, an additional byte that is padded with, e.g. 0's, will only be added (if necessary) to the encoded representation of the input data array generated by the lossless encoding scheme where the encoded representation of the input data array generated by the lossless encoding scheme is less than or equal to (does not exceed) 46 bytes in size.

The Applicants have recognised in this regard that where there is a maximum permitted size that a losslessly encoded data array encoded by the auxiliary encoding scheme can have, then for any encoded data array size that is greater than that maximum “auxiliary encoding” permitted size, the decoder can determine that the auxiliary encoding scheme cannot have been used for the data array (that the lossless encoding scheme must have been used for the data array) based on the size of the encoded representation of the input array alone. This being the case, there is then no need to ensure that the encoded representation of input array ends with a bit having the particular value indicative that the lossless encoding scheme was used, as the size of the encoded representation of the input data array on its own can be used to determine that.

This may also help to avoid the situation where an encoded representation of an input data array generated by the lossless encoding scheme is padded with an additional byte such that it then has a size corresponding to an unencoded (uncompressed) representation of the input data array, which again may simplify the decoding of an input data array at the decoder.

Correspondingly, the decoding process and decoder in an embodiment operates to and is configured to use an indicated size of an encoded representation of an input data array to determine whether that encoded representation could only have been generated using the lossless encoding scheme or could have been generated using either the lossless encoding scheme or the auxiliary encoding scheme, and then (only) in the latter case, will and does the decoding process/decoder use the value of the bit at the end of the encoded data array to determine whether the lossless encoding scheme or the auxiliary encoding scheme has been used for the array in question.

It will be appreciated from the above, that in an embodiment, the auxiliary encoding scheme that is used in the technology described herein will operate to, when encoding a data array, encode an input data array (e.g. block) to a fixed sized data packet by generating two streams of encoded data, with one encoded data stream being stored starting from the beginning of the output fixed size data packet growing towards the end of the output fixed size data packet, and the other encoded data stream being stored starting at the end of the output fixed size data packet and growing towards the beginning of the output fixed size data packet.

Furthermore, when the auxiliary encoding scheme is able to completely encode a data array into the fixed size data packet, the two encoded data streams will then, where possible, be packed into a smaller data packet, with that smaller data packet then being provided as the output of the auxiliary encoding scheme.

It is believed that such operation of an encoding scheme may be new and advantageous in its own right.

Thus, another embodiment of the technology described herein comprises a method of encoding a data array, the method comprising:
using an encoding scheme that can encode at least some data arrays in a lossless manner such that the original array of data elements can be reconstructed from the encoded data, to encode a data array, the encoding scheme:
encoding the input data array to a fixed sized data packet by generating two streams of encoded data, with one encoded data stream being stored starting from the beginning of the output fixed size data packet growing towards the end of the output fixed size data packet, and the other encoded data stream being stored starting at the end of the output fixed size data packet and growing towards the beginning of the output fixed size data packet;
the method further comprising:
when the encoding scheme is able to losslessly encode the data array into the fixed size data packet, repacking the two encoded data streams into a new data packet, and providing that new data packet as the output of the encoding scheme.

Correspondingly, another embodiment of the technology described herein comprises an apparatus (an encoder) for encoding a data array, the apparatus comprising:
an encoding circuit configured to encode a data array using an encoding scheme that can encode at least some data arrays in a lossless manner such that the original array of data elements can be reconstructed from the encoded data to encode the data array, the encoding scheme:
encoding an input data array to a fixed sized data packet by generating two streams of encoded data, with one encoded data stream being stored starting from the beginning of the output fixed size data packet growing towards the end of the output fixed size data packet, and the other encoded data stream being stored starting at the end of the output fixed size data packet and growing towards the beginning of the output fixed size data packet;
the apparatus (encoder) further comprising:
a processing circuit configured to, when the encoding scheme is able to completely encode the data array into the fixed size data packet, repack the two encoded data streams into a new data packet, and provide that new data packet as the output of the encoding scheme.

As will be appreciated by those skilled in the art, these embodiments of the technology described herein can, and in an embodiment do, include any one or more or all of the features of the technology described herein described herein, as appropriate.

Thus, for example, the data array that is being encoded is in an embodiment a (respective) block that is part of an overall data array, e.g., and in an embodiment, that is being encoded on a block-by-block basis.

Similarly, the two (the forward and reverse) data streams are in an embodiment (re)packed into a smaller data packet (when possible) and the (re)packing in an embodiment comprises removing some or all of any unused space from the fixed size encoded data packet that the encoding scheme initially encoded the input array into.

In an embodiment the (re)packing of the encoded data array is done so as to (re)pack the encoded representation of the input data array into an appropriately aligned (e.g. and in an embodiment, byte-aligned) (smaller) encoded data packet, and in an embodiment so as to remove as much unused (redundant) “space” from the initial fixed size packet as possible.

Correspondingly, the encoding scheme can be any suitable and desired encoding scheme that is capable of encoding an input data array in a lossless manner, at least in certain circumstances.

Similarly, the encoding scheme is in an embodiment an encoding scheme that is configured to encode an array of data in a lossless manner, but subject to a maximum permitted encoded data size for the array, i.e. such that when an array of data can be fully encoded in a lossless manner within the permitted maximum data encoded data size, the array will be encoded in a lossless manner, but when the array cannot be encoded in a lossless manner within the permitted maximum data size, the encoding will “fail”.

In an embodiment, the encoding scheme is based on a “lossy” encoding scheme, and/or in an embodiment encodes a data array by first performing a frequency domain transform, and then performing bit plane coding of the frequency domain coefficients (as discussed above).

The encoding scheme is again in an embodiment a block-based encoding scheme, which operates on respective blocks of an overall input data array, for example, and in an embodiment, to encode respective blocks of an overall input data array to respective fixed-size data packets.

The method in an embodiment further comprises (and the apparatus is configured to) providing an indication of whether the encoding scheme was able to encode the input data array in a lossless manner or not. In an embodiment, the method in an embodiment comprises (and the apparatus is configured to) providing an indication that the encoding scheme was not able to (was other than able to) encode the input data array in a lossless manner when the encoding scheme was not able to (was other than able to) losslessly encode the data array into the fixed size data packet.

The method in an embodiment further comprises (and the apparatus is configured to), at least (and in an embodiment only) in the case where the encoding scheme was able to encode the input data array in a lossless manner, providing an indication of the (data) size of the generated encoded representation of the input data array. In this case, the size of the new data packet (after (re)packing of the data streams) is in an embodiment provided as the (data) size of the generated encoded representation of the input data array.

Correspondingly, the method in an embodiment further comprises (and the apparatus is configured to), at least (and in an embodiment only) in the case where the encoding scheme was able to encode the input data array in a lossless manner, if necessary providing (additional) information allowing the positions of the forward and reverse bit streams in the “repacked” encoded representation of the input data array to be determined (such as the position of the end of the forward bit stream and/or the position of the start of the reverse bit stream in the repacked, new packet).

The method in an embodiment further comprises (and the apparatus is configured to), (at least) in the case where the encoding scheme was able to encode the input data array in a lossless manner, including a bit having a value that indicates that the encoding scheme has been used in the generated encoded representation of the input data array, in an embodiment at the end of the encoded representation of the input data array that is produced by the encoding scheme.

The above describes the process of encoding a data array in a lossless manner in the technology described herein.

The encoded data array generated by the encoder/encoding process may be output to a memory for storage (e.g. for subsequent decoding and/or transmission), or may be output to an external device (e.g. for subsequent decoding and optionally display).

When it is desired to subsequently access or use some or all of a data array that has been encoded in the manner of the technology described herein, the encoded data array may be processed by a decoder (decoding circuit)/decoding process, to reproduce the original input data array (or a part or parts thereof).

When decoding an encoded data array (e.g. block), the decoding process/decoder should, and in an embodiment does, determine whether the array to be decoded has been encoded using the lossless or auxiliary encoding scheme, and then decode the array (e.g. block) using the determined decoding scheme accordingly. As discussed above, this determination is in an embodiment based on information in and/or associated with the encoded data array, such as the size of the encoded data array, and/or an indication in the encoded data array indicating which encoding scheme was used.

The technology described herein also extends to corresponding methods and apparatus for decoding data that has been encoded in the manner of the technology described herein.

Thus, another embodiment of the technology described herein comprises a method of operating a data decoder that is capable of decoding data using two different decoding schemes, including a lossless decoding scheme configured to decode data that has been encoding using a lossless encoding scheme that will encode a data array in a lossless manner such that the original array of data elements can be reconstructed from the encoded data, and an auxiliary decoding scheme configured to decode data that has been encoded using an auxiliary encoding scheme that can encode at least some data arrays in a lossless manner such that the original array of data elements can be reconstructed from the encoded data, the method comprising:
when it is desired to decode a data array that has been encoded in a lossless manner:
determining whether to decode the data array using the lossless decoding scheme or using the auxiliary decoding scheme; and
decoding the data array using the determined decoding scheme.

Another embodiment of the technology described herein comprises an apparatus for decoding encoded data (a data decoder), comprising:
a decoding circuit configured to decode data that has been encoded using a lossless encoding scheme that will encode a data array in a lossless manner such that the original array of data elements can be reconstructed from the encoded data; and
a decoding circuit configured to decode data that has been encoded using an auxiliary encoding scheme that can encode at least some data arrays in a lossless manner such that the original array of data elements can be reconstructed from the encoded data;
the apparatus (decoder) further comprising:
a processing circuit configured to, when it is desired to decode a data array that has been encoded in a lossless manner:
determine whether the data array should be decoded using the lossless decoding scheme or using the auxiliary decoding scheme; and
cause the data array to be decoded using the determined decoding scheme.

As will be appreciated by those skilled in the art, these embodiments of the technology described herein can, and in an embodiment do, include any one or more or all of the features of the technology described herein described herein, as appropriate.

Thus, for example, the data array that is being decoded is in an embodiment a (respective) block that is part of an overall data array, e.g., and in an embodiment, that is being decoded on a block-by-block basis.

In general, the decoder/decoding process will be, and is in an embodiment, operable to, and operates to, decode an encoded data array to recover a (lossless) representation of the original source data (e.g. image or part of an image) that was encoded, and then provide this data for use (e.g. display) as desired. Thus, once a data array has been decoded, the decoder/decoding process may then output the decoded data, e.g. to storage (memory), and/or to another processing unit, e.g. for display or to be used in further processing.

A data array could simply be decoded as a whole in the manner of the technology described herein, and in one embodiment, that is what is done.

In an embodiment, the decoding process comprises decoding an overall data array (e.g. image) on a block-by-block basis, i.e. respective encoded block(s) are decoded by determining on a block-by-block basis, whether to decode the block using the lossless decoding scheme or using the auxiliary decoding scheme.

Thus, in an embodiment, the decoding method comprises:
for an encoded block, and in an embodiment for each of a plurality of encoded blocks, representing some or all of an overall data array to be decoded:
determining whether to decode the block using the lossless decoding scheme or using the auxiliary decoding scheme; and
decoding the block using the determined decoding scheme.

Correspondingly, in an embodiment, the processing circuit is configured to:
determine whether an encoded block representing part of an overall encoded data array to be decoded should be decoded using the lossless decoding scheme or using the auxiliary decoding scheme; and
cause the block to be decoded using the determined decoding scheme.

The lossless decoding scheme that is supported by the decoder and used in the technology described herein can be any suitable and desired lossless data decoding scheme, i.e. that can decode a data array in a lossless manner such that the original array of data elements can be perfectly reconstructed from the encoded data. It should be, and is in an embodiment a corresponding decoding scheme to the lossless encoding scheme that is/was used to encode the data array that is to be decoded.

Thus, in an embodiment, the lossless decoding scheme is as described in one or more of the Applicant's U.S. Pat. Nos. 8,542,939 B2, 9,014,496 B2, 8,990,518 B2, 9,116,790 B2, and 11,023,132 B2, the contents of which are incorporated herein by reference in their entirety.

Other forms of lossless decoding scheme could be used if desired.

In an embodiment, the lossless decoding scheme is operable to and configured to determine whether an encoded data array to be decoded is already in an unencoded (uncompressed) form (as discussed above in relation to the lossless encoding scheme). This is in an embodiment done based on (an indication of) the size of the data array to be decoded.

In an embodiment, when a data array to be decoded has a particular, in an embodiment selected, predetermined size, the lossless decoder/decoding scheme determines that the data array to be decoded is in an unencoded (uncompressed) form and so simply outputs the data array to be decoded “as is” as the decoded output for the data array.

In this case, the “unencoded” data array size that the lossless decoding process interprets as indicating an unencoded (uncompressed) data array is in an embodiment set to be the size of an unencoded (uncompressed) data array for the particular size (in terms of the number of data elements) and data (element) format of the data array to be decoded.

Thus, for example, in the case where the array to be decoded represents a 4×4 pixel block having an R8G8B8 pixel format, the “unencoded” size that the lossless decoding process interprets as indicating an unencoded (uncompressed) array (block) will be 48 bytes.

Correspondingly, in an embodiment, a different “unencoded” encoded data array size is used for different data array formats and block sizes. Accordingly, there may be a plurality of “unencoded” data array sizes, with the size to be used for any given data array to be decoded being selected and set according to the format and size (in terms of the input data elements (e.g. pixels)) of the data array to be decoded.

The auxiliary decoding scheme that is supported by the decoder and used in the technology described herein can be any suitable and desired decoding scheme that can decode a data array that has been encoded using an encoding scheme that is capable of encoding an input data array in a lossless manner, at least in certain circumstances.

It should be, and is in an embodiment a corresponding decoding scheme to the auxiliary encoding scheme that is/was used to encode the data array that is to be decoded.

Thus, in an embodiment, the auxiliary decoding scheme is based on a lossy decoding scheme, in an embodiment as is described in one or more of the Applicant's US Patent Publication No. US 2022-0014767 and the Applicant's U.S. Pat. No. 11,515,961, the contents of which are incorporated herein by reference in their entirety.

In an embodiment, the auxiliary decoding scheme operates to and is configured to identify and decode (in an embodiment separately) two (bit) streams (in an embodiment a “forward” bit stream and a “reverse” bit stream, as discussed above), in/from a data array to be decoded (as discussed above).

This is in an embodiment based on (and uses) information allowing the positions of the two (the forward and reverse) bit streams in the encoded array to be decoded to be determined (such as the size of the encoded (compressed) data, and/or the position of the end of the forward bit stream and/or the position of the start of the reverse bit stream in the encoded array), which information is in an embodiment associated with the array to be decoded (and provided to the decoder/decoding process).

In an embodiment, the auxiliary decoding scheme only supports decoding of data arrays having a particular, in an embodiment selected, in an embodiment predetermined, data array format or formats (e.g., and in an embodiment, in terms of the data format for the data elements of the input data array).

Thus, in an embodiment, the decoding method comprises (and the processing circuit of the decoder is correspondingly configured to), when it is desired to decode a data array that has been encoded in a lossless manner:
(in an embodiment first) determining, based on the data format of the data array to be decoded, whether to decode the data array using the lossless decoding scheme (and when it is determined on this basis to decode the data array using the lossless decoding scheme, decoding the data array using the lossless decoding scheme).

Accordingly, in embodiments of the technology described herein at least, the lossless decoding scheme is (potentially) used whenever it is desired to decode a data array that has been encoded in a lossless manner, but the auxiliary encoding scheme is only (potentially) used to decode a data array that has been encoded in a lossless manner for data arrays having one of a particular, in an embodiment selected, in an embodiment predetermined, set of one or more, and in an embodiment plural, different data array formats.

Correspondingly, in an embodiment, the lossless decoding scheme is usable to decode (supports decoding of) data arrays having a data format in any one of a set of plural different data formats, but the auxiliary decoding scheme is only usable to decode (supports decoding of) data arrays having one of a subset of the data array formats that are supported by the lossless encoding scheme.

It can be determined whether to decode a data array using the lossless decoding scheme or the auxiliary decoding scheme (where that is an option) in any suitable and desired manner.

In an embodiment, this is based (at least in part) on the size of the encoded data array that is to be decoded. In an embodiment, when the (data) size of the data array to be decoded is greater than a particular, in an embodiment selected, in an embodiment predetermined, threshold maximum size, it is determined that the data array to be decoded will not have been (will other than have been) encoded using the auxiliary encoding scheme, and so, correspondingly, it will be determined that the data array should be decoded using the lossless decoding scheme.

Thus, in an embodiment, determining whether to decode a data array using the lossless decoding scheme or using the auxiliary decoding scheme comprises determining whether the data array (e.g. block of an overall data array) to be decoded is greater than a threshold (data) size, and when the data array to be decoded is greater than the threshold size, determining to decode the data array using the lossless decoding scheme (and decoding the data array using the lossless decoding scheme).

Correspondingly, in an embodiment, in the case where the size of the encoded data array to be decoded is less than or equal to the threshold size, it will be determined that the data array should be decoded using one of the auxiliary decoding scheme and the lossless decoding scheme.

The size of the encoded data array to be decoded is in an embodiment provided to the decoder/decoding process for this purpose, for example by being associated with the data array to be decoded.

The threshold data size that is used for this purpose can be any suitable and desired data size. It is in an embodiment a (the) threshold data size above which the auxiliary encoding scheme will not be used (above which the auxiliary encoding scheme “fails”) (as discussed above), and this is in an embodiment based on the uncompressed (unencoded), input data size for a particular, in an embodiment selected, in an embodiment predetermined, data array size (in terms of the number of data elements) and data (e.g. pixel) format, and is in an embodiment set at a particular, in an embodiment selected, and in an embodiment predetermined, margin smaller than the corresponding uncompressed data array (data) size (i.e. smaller than the uncompressed input data array size). As discussed above, this margin is in an embodiment set to be at least two, and in an embodiment two, bytes smaller than the size of an original (uncompressed) input data array that is being considered.

It would be possible in this regard to have a different permitted threshold data size for determining that a data array should be decoded using the lossless decoding scheme for each different input data array format and/or block size (in terms of the number of data elements) that the auxiliary decoding scheme supports (and in one embodiment that is what is done).

In an embodiment, there is only one, single, threshold data size that is used for determining that a data array should be decoded using the lossless decoding scheme (and that is used irrespective of the size and data format of the data array that is actually to be decoded).

This may then simplify the determination of whether the auxiliary decoding scheme should potentially be used or not.

In an embodiment where a single threshold data size is used for this purpose, that single threshold data size is in an embodiment based on the smallest uncompressed data block size for the data array formats and data block sizes that the lossy decoding scheme supports, and is in an embodiment set to a particular, in an embodiment selected, and in an embodiment predetermined, margin (and in an embodiment a margin of at least 2, and in an embodiment of 2, bytes) smaller than the smallest uncompressed data block size for the data array formats and data block sizes that the auxiliary decoding scheme supports.

Thus, for example, in the case where the smallest uncompressed data block size that the auxiliary decoding scheme supports is a 4×4 pixel block having an R8G8B8 pixel format, the (single) threshold data size that is used for determining that a data array should be decoded using the lossless decoding scheme is in an embodiment set to 46 bytes.

In the case where it cannot be determined based on the size of the array to be decoded to use the lossless decoding scheme (so it is still open for the array to need to be decoded using either the lossless or the auxiliary decoding scheme), the decoding process will then have to, and does then in an embodiment, make a further determination of whether to decode the encoded data array using the lossless or the auxiliary decoding scheme.

This can be done in any suitable and desired manner. In an embodiment, this is based on an indication of the encoding scheme that has been used for the data array that is to be decoded that is provided for (associated with) the data array to be decoded (and that is provided to the decoder/decoding process).

As discussed above, in an embodiment, an indication of the encoding scheme that has been used is provided in (included in) the encoded representation of a data array itself. In an embodiment, the last (final) bit in an encoded (representation of a) data array is used to indicate to the decoder (and used by a decoder to select between) which of the auxiliary and lossless decoding schemes to use for the data array in question.

Thus, in an embodiment, and as discussed above, the determination of whether to decode an encoded data array using the lossless decoding scheme or using the auxiliary decoding scheme is based (where necessary) on an indication that is included in the encoded data array to be decoded of which encoding scheme has been used to encode the data array. In an embodiment, as discussed above, this is based on the value of a bit having a particular, in an embodiment selected, in an embodiment predetermined, bit position in the encoded data array to be decoded, in an embodiment the value of the final bit in the encoded data array (with in an embodiment a bit value of 0 indicating that the lossless decoding scheme should be used, and a bit value of 1 indicating that the auxiliary decoding scheme should be used).

Thus, in an embodiment, determining whether to decode an array using the lossless decoding scheme or using the auxiliary decoding scheme is based on at least one of:
the size of the array to be decoded; and
an indication in the array to be decoded of the encoding scheme that has been used for the array.

Correspondingly, in an embodiment, determining whether to decode an array using the lossless decoding scheme or using the auxiliary decoding scheme comprises:
determining whether the data array to be decoded is greater than a threshold (data) size; and
when it is determined that the data array to be decoded is greater than the threshold size, determining to decode the data array using the lossless decoding scheme, and decoding the data array using the lossless decoding scheme;
when it is determined that the data array to be decoded is not (is other than) greater than the threshold size, determining from an indication of the encoding scheme that has been used for the data array included in the data array to be decoded, whether to decode the data array using the lossless decoding scheme or using the auxiliary decoding scheme, and decoding the data array using the determined decoding scheme.

As will be appreciated from the above, in the embodiments of the technology described herein at least, depending on which decoding scheme it was determined to use for a given array to be decoded, the decoded output array will either be an output array generated using the auxiliary decoding scheme, or an output array provided by the lossless decoding scheme (which in an embodiment may be a decoded array, or simply the array to be decoded where it is determined that the array to be decoded was in an unencoded (uncompressed) form).

The encoding and decoding apparatuses discussed above may generally be provided as part of a data processing system. For example, the apparatuses may comprise part of an image and/or video processing system that includes a camera, such as a digital camera, mobile phone or tablet.

In general, the processes described herein in any embodiment may be performed by any desired and suitable apparatus. For example, the processes described herein in any embodiment may be performed by an image or video processor (codec), a graphics processor, etc.. The data processing apparatus described herein in any embodiment may therefore comprise or may be a video processor or a graphics processor. The data processing apparatus described herein in any embodiment may comprise, or may be, or may form part of, a system on chip (SoC).

As will be appreciated by those skilled in the art, the encoding/decoding apparatus of the technology described herein described herein may be part of an overall data processing system that includes, for example, a host (e.g. central) processor. The host processor may, for example, execute applications that require data processing by the encoding/decoding apparatus. The host processor may send appropriate commands and data to the encoding/decoding apparatus to control it to perform the data encoding/decoding operations and to generate and/or use an output required by applications executing on the host processor. To facilitate this, the host processor may execute a driver for the encoding/decoding apparatus.

In embodiments, the apparatus or system may comprise, and/or may be in communication with, one or more memories and/or memory devices that store the data described herein, and/or store software for performing the processes described herein. The apparatus or system may comprise, and/or may be in communication with a display for displaying images based on the data elements of the arrays. The apparatus or system may comprise, and/or may be in communication with a camera, graphics processor or video processor, that generates the data arrays.

The memory referred to herein may be any desired and suitable memory of or for the data processing apparatus. The memory may be external to the data processing apparatus, e.g. video processor and/or system on chip (SoC). The memory may be, for example, main system memory.

The technology described herein described herein can be used for all forms of data arrays that a data processing apparatus may provide and/or use, such as images or frames for display. Thus, as indicated above, the arrays of data elements may comprise image data and/or may correspond to images or frames of image data.

In an embodiment, the various functions of the technology described herein described herein are carried out on a single data (e.g. image) processing platform that provides and/or uses the arrays of data elements.

The technology described herein described herein can be implemented in any suitable system, such as a suitably configured computer or micro-processor based system. In an embodiment, the technology described herein described herein is implemented in a computer and/or micro-processor based system.

The various functions of the technology described herein described herein can be carried out in any desired and suitable manner. For example, the steps and functions of the technology described herein described herein can be implemented in hardware or software, as desired. Thus, for example, unless otherwise indicated, the various circuitry, functional elements, stages, and “means” of the technology described herein described herein may comprise a suitable processor or processors, controller or controllers, functional units, circuits, circuitry, processing logic, microprocessor arrangements, etc., that are operable to perform the various steps or functions, etc., such as appropriately dedicated hardware elements (processing circuits/circuitry) and/or programmable hardware elements (processing circuits/circuitry) that can be programmed to operate in the desired manner.

In particular, it is contemplated that the encoder may be implemented either in hardware or software, as desired. Thus, for example, the encoder may comprise a suitable processor or processors, controller or controllers, functional units, (encoding) circuits/circuitry, processing logic, microprocessor arrangements, etc., that are operable to perform the various encoding steps or functions, etc., as described herein such as appropriately dedicated hardware elements (processing circuits/circuitry) and/or programmable hardware elements (processing circuits/circuitry) that can be programmed to operate in the desired manner.

Similarly, the decoder can be implemented in hardware or software, as desired. Thus, for example, the decoder may comprise a suitable processor or processors, controller or controllers, functional units, (decoding) circuits/circuitry, processing logic, microprocessor arrangements, etc., that are operable to perform the various encoding steps or functions, etc., as described herein such as appropriately dedicated hardware elements (processing circuits/circuitry) and/or programmable hardware elements (processing circuits/circuitry) that can be programmed to operate in the desired manner.

The various steps or functions, etc., of the technology described herein described herein may be duplicated and/or carried out in parallel on a given processor. Equally, the various processing stages may share processing circuits/circuitry, etc., if desired.

Subject to any hardware necessary to carry out the specific steps or functions, etc., discussed above, the system can otherwise include any one or more or all of the usual functional units, etc., that data processing apparatus and/or systems include.

The various data processing stages can accordingly be implemented as desired and in any suitable manner, and can perform any desired and suitable functions, respectively. Similarly, the various data can be defined and stored in any suitable and desired manner.

It will also be appreciated by those skilled in the art that all of the described embodiments of the technology described herein described herein can, and in an embodiment do, include, as appropriate, any one or more or all of the features described herein.

The methods in accordance with the technology described herein described herein may be implemented at least partially using software e.g. computer programs. Thus, further embodiments the technology described herein described herein comprise computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processor. The data processor may be a microprocessor system, a programmable FPGA (field programmable gate array), etc..

The technology described herein described herein also extends to a computer software carrier comprising such software which when used to operate a data processing apparatus or system comprising a data processor causes in conjunction with said data processor said apparatus or system to carry out the steps of the methods of the technology described herein described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein described herein need be carried out by computer software and thus in further embodiments comprise computer software and such software installed on a computer software carrier for carrying out at least one of the steps of the methods set out herein.

The technology described herein described herein may accordingly suitably be embodied as a computer program product for use with a computer system. Such an implementation may comprise a series of computer readable instructions either fixed on a tangible, non-transitory medium, such as a computer readable medium, for example, diskette, CD, DVD, ROM, RAM, flash memory, or hard disk. It could also comprise a series of computer readable instructions transmittable to a computer system, via a modem or other interface device, either over a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology described herein, present or future, including but not limited to, semiconductor, magnetic, or optical, or transmitted using any communications technology described herein, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

The drawings show elements of data processing apparatuses and systems that are relevant to embodiments of the technology described herein described herein.

As will be appreciated by those skilled in the art there may be other elements of the data processing apparatus and system that are not illustrated in the drawings. It should also be noted here that the drawings are only schematic, and that, for example, in practice the shown elements may share significant hardware circuits, even though they are shown schematically as separate elements in the drawings (or, conversely, where elements are shown as sharing significant hardware circuits, these may in practice comprise separate elements).

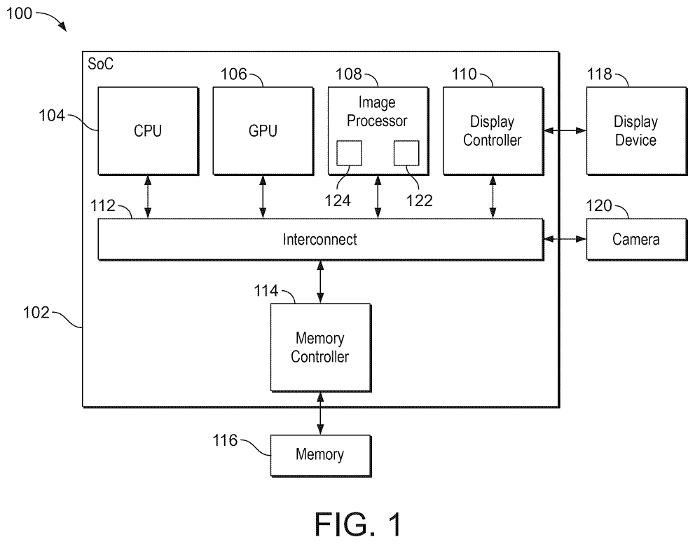

FIG. 1 shows schematically an embodiment of a data processing system 100 that can provide and use data arrays, such as images or video frames for display, that have been encoded in the manner of the technology described herein. It will be appreciated that FIG. 1 merely shows one example of a system that is suitable for use with the technology described herein, and that various other arrangements are possible.

In this embodiment, the system 100 comprises a data processing apparatus in the form of a system on chip (SoC) 102. The system 100 also comprises off-chip (main) memory 116, a display device 118 and a video camera 120.

The SoC 102 comprises a central processing unit (CPU) 104, a graphics processing unit (GPU) 106, an image/video processor 108, a display controller 110, an interconnect 112 and a memory controller 114.

As is shown in FIG. 1, the CPU 104, GPU 106, image/video processor 108, and display controller 110 communicate with each other via the interconnect 112 and with the memory 116 via the interconnect 112 and memory controller 114. The display controller 110 also communicates with the display device 118. The video camera 120 also communicates with the SoC 102 via the interconnect 112.

In embodiments, the image/video processor 108 reads in image data from memory 116, encodes the image data (e.g. in the manner of the technology described herein) using a suitable encoder circuit 122, and then outputs that encoded image data, e.g. for storage in memory 116 or for streaming to another device. The encoded image data can later be retrieved and decoded, e.g. by a suitable decoder circuit 124 of the image/video processor 108, or received and decoded by another device.

The decoded image data can then be output, e.g. by the display controller 110 to the display device 118 or by another device, for display.

Although the image/video processor 108 is shown as having a separate encoder circuit 122 and decoder circuit 124 it will be appreciated that this is merely schematic and that these may form part of a common encoding/decoding circuit.

Similarly, although FIG. 1 shows the image processor 108 as having an encoder 122 and decoder 124 for encoding and decoding images, other units of the data processing system and SoC shown in FIG. 1, such as the graphics processing unit (GPU) 106, could also or instead include an appropriate encoder circuit and decoder circuit. Equally, there could be a separate encoding and decoding unit or units (codec unit) that can perform encoding and decoding of data arrays, such as images, and that is accessible to and shared by one or more of the other units, such as the GPU 106, image processor 108 and display controller 110 of the data processing system.

Other arrangements would, of course, be possible.

In the present embodiments, the encoder circuit 122 is, in accordance with the technology described herein, operable to and operates to, when it is desired to encode a data array in a lossless manner, where appropriate encode the data array using both a lossless and an auxiliary encoding scheme, and to then select an output from one of those encoding schemes to use for the lossless encoded representation of the input data array.

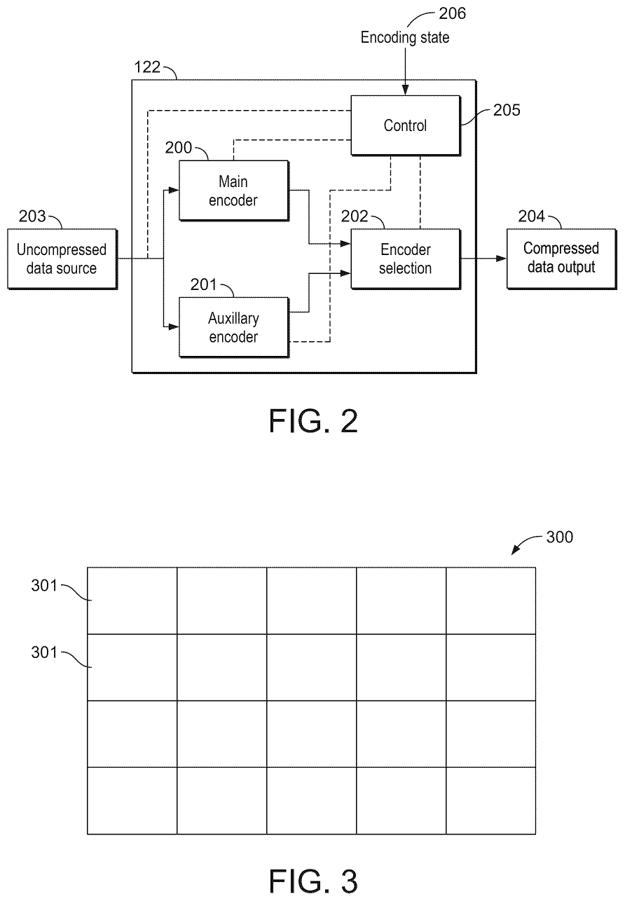

FIG. 2 shows the encoder circuit 122 in the present embodiments in more detail. As shown in FIG. 2, the encoder circuit 122 includes both a main encoder (encoding circuit) 200, and an auxiliary encoder (encoding circuit) 201, both of which are operable to encode uncompressed data 203 that it is desired to compress (encode).

Furthermore, as shown in FIG. 2, the encoder circuit 122 further comprises an encoder selection circuit 202 that is operable to select the output of one of the main encoder 200 and the auxiliary encoder 201 to provide as the encoded data output for data that is being encoded in a lossless manner.

In particular, the encoder selection circuit 202 is configured to and operable to determine whether the output from the main encoder 200 or from the auxiliary encoder 201 should be used as the output representing an input uncompressed block of an overall data array when it is desired to compress an overall data array in a lossless manner in a block-by-block manner.

As shown in FIG. 2, the encoder circuit 122 also includes an appropriate control circuit (controller) 205 which is operable to control the operation of and inputs to the main encoder 200, the auxiliary encoder 201, and the encoder selection circuit 202. The control circuit 205 receives appropriate encoding state information 206 for a data array to be encoded, such as the data element (e.g. pixel) format for the data array to be encoded, and any other known information that would be useful for the encoding process to know/consider.

In the present embodiments, the uncompressed data 203 that is to be encoded by the encoding circuit 122 will comprise (part of) an (input) data array, comprising an array of data elements such as an image (e.g. representing a frame to be displayed or a graphics texture).

In the present embodiments, the encoding circuit 122 is configured to encode an overall data array as respective blocks, each representing a respective region of the overall input data array (i.e. on a block-by-block basis). Thus each data array that is encoded will be a respective block (part of) an overall data array to be encoded.

FIG. 3 illustrates this, and shows an exemplary overall input data array 300 subdivided into a plurality of blocks 301, each of which blocks will be encoded separately and independently of the other blocks, and provided as a respective output encoded block. The output encoded blocks can then be decoded to provide a decoded version of the overall input data array 300.

In the present embodiments, the main encoder 200 of the encoder circuit 122 is configured to and operable to encode input data (a respective block of an overall input data array) in a lossless manner.

In the present embodiments, the main (lossless) encoder 200 uses a lossless encoding scheme as described in one or more of the Applicant's U.S. Pat. Nos. 8,542,939 B2, 9,014,496 B2, 8,990,518 B2, 9,116,790 B2, and 11,023,132 B2, the contents of which are incorporated herein by reference in their entirety.

Other lossless encoding schemes could also or instead be used, if desired.

In the present embodiments, the main (lossless) encoder 200 is configured to output an unencoded (uncompressed) version of an input data block to be compressed as the output of the lossless encoding in the case where the lossless encoding results in an encoded (compressed) data block size that is greater than a particular, predetermined threshold size. This is so as to ensure that the lossless encoding scheme will not provide an output that is greater than the size of the input data block in its original form, and also so as to, as will be discussed in more detail below, simplify the decoder operation when decoding blocks of an overall data array that has been losslessly encoded in the manner of the present embodiments.

In the present embodiments, the threshold data size for outputting an unencoded (uncompressed) version of an input data block by the main (lossless) encoder is set to be a data size that is 1 byte smaller than the (uncompressed) input data block size.

Thus, for a 4×4 pixel block having an R8G8B8 format, the threshold size above which the input data block is simply output in an uncompressed form will be 47 bytes. For other input data block sizes and/or data element/pixel formats, appropriate threshold sizes are correspondingly determined and used.

In the present embodiments, this is done under the control of the control unit 205, which will determine and provide to the main (lossless) encoder 200 the appropriate threshold for determining whether to output an input data block in an uncompressed form, based on the encoding state data 206 that the control unit 205 receives.

Thus, in the present embodiments, the output of the main (lossless) encoder 200 when encoding an input data block in a lossless manner could either be an appropriately losslessly encoded representation of the input data block, or the input data block in its original (unencoded) form.

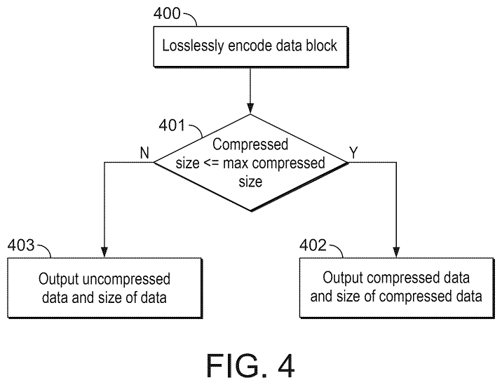

FIG. 4 illustrates this operation of the main (lossless) encoder 200 in the present embodiments.

As shown in FIG. 4, the main (lossless) encoder 200 will for a given input data block to be encoded, losslessly encode that data block (step 400), and then compare the size of the resulting losslessly encoded block with the threshold size above which the input data block is simply output in an uncompressed form (as discussed above) (step 401).

In the case where the encoded data block is smaller than or equal to the threshold maximum compressed size, then the encoded (compressed) representation of the input data block is output as the result of the lossless encoding of the data block, together with an indication of the size of the encoded data block (step 402).

On the other hand, where the compressed (encoded) data block is larger than the threshold maximum encoded size, the original, uncompressed (unencoded), input data block is instead output as the result of the encoding of the input data block by the main (lossless) encoder 200, together with an indication of the size of the data block (which will be the (data) size of the uncompressed input data block) (step 403).

The auxiliary encoder 201 is operable to and configured to encode an input data array (block) using an encoding scheme that is based on a lossy encoding scheme but that in certain circumstances can in fact encode a block of a data array losslessly. More particularly, the auxiliary (lossy) encoder 201 uses and performs an encoding scheme that encodes in a lossless manner but subject to a permitted maximum encoded data size for a given input block of data (i.e. such that the lossless encoding will fail (not succeed) if the input data cannot be losslessly encoded within the maximum permitted output data size).

In the present embodiments, the auxiliary (lossy) encoder 201 uses an encoding scheme that encodes a block of an overall data array by first performing a frequency domain transform operation on the block of data elements to transform the spatial representation of the data block into the frequency domain, and then performing bit plane coding on the frequency domain coefficients to decompose the frequency domain coefficients into a set of bit plane arrays containing the respective (binary) bit values at each bit position for each of the frequency domain coefficients. The bit plane represented data is then encoded by packing bits from the most significant (top) bit plane downwards into a fixed size data packet until the data packet is full.

More particularly, in the present embodiments, the auxiliary encoding scheme is based on the encoding scheme(s) as described in one or more of the Applicant's US Patent Publication No. US 2022-0014767 and the Applicant's U.S. Pat. No. 11,515,961, the contents of which are incorporated herein by reference in their entirety.

Other auxiliary encoding schemes (which can potentially encode input data in a lossless manner) could also or instead be used, if desired.

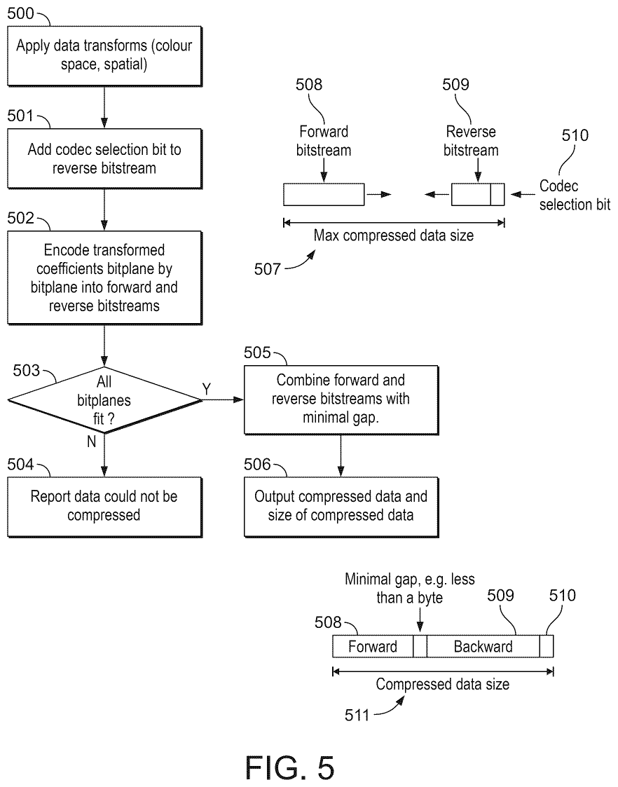

FIG. 5 shows the operation of the auxiliary encoder 201 in the present embodiments when encoding an input data block in more detail.

As shown in FIG. 5, for an input data block to be encoded by the auxiliary encoder 201, the auxiliary encoder 201 first applies the appropriate data transforms to the input data block (step 500).

As shown in FIG. 5, in the present embodiments, the auxiliary encoder 201 operates to pack the encoded bit stream into a fixed sized data packet 507 from both ends of that data packet, by encoding a “forward” bit stream 508 starting at the beginning of the data packet and growing towards the end of the data packet, and a “reverse” bit stream 509 starting at the end of the data packet and growing towards the front of the data packet.

The maximum compressed data size (the fixed size packet 507) that the auxiliary encoding is encoded into is set in the present embodiments to be a data size that is 2 bytes smaller than the smallest (uncompressed) input data block size that is supported by the encoder circuit 122. Thus, in the case where the smallest uncompressed input data block size will be a 4×4 pixel block having an R8G8B8 format, the maximum compressed data size (packet size) for the auxiliary encoding scheme is set to 46 bytes. Other arrangements would, of course, be possible, for different smallest input data block sizes. Equally, a different maximum compressed data size could be set for different input data block formats/sizes, if desired.

This then will ensure that the result of encoding the input data block using the auxiliary encoding scheme will only (potentially) be used as the output of the lossless encoding of an input data block in the case where the auxiliary encoding scheme results in a losslessly encoded output data block that is a particular margin smaller than the size of the (smallest supported) input data block in its original form. As will be discussed further below, this helps to simplify the decoder operation when decoding a data array that has been losslessly encoded in the manner of the present embodiments.

In the present embodiments, and as will be discussed in more detail below, in order to allow a decoder to identify when the output of the auxiliary encoder 201 has been used as the output for a losslessly encoded input data block, a codec (encoder) selection bit 510 is included in the encoded representation of the input data block. In the present embodiments, this codec selection bit is set to “1” and is added at the end of the encoded data packet, as shown in FIG. 5.

Thus, as shown in FIG. 5, once the data transforms have been applied to the input block, the codec selection bit “1” 510 is first added at the end of the fixed sized data packet 507 that the block will be encoded into (step 501).

The transform coefficients are then encoded bit by bit plane into forward 508 and reverse 509 bit streams in the fixed size data packet 507 (step 502). This is done until the fixed size data packet is full or all the bit planes have been able to be fitted into the fixed size data packet before the forward and reverse bit streams meet in the fixed size data packet.

It is accordingly then determined whether all of the bit planes fitted in the permitted maximum compressed data size fixed sized data packet 507 or not (step 503).

In the case where all of the bit planes could not be completely fitted within the permitted fixed size data packet 507, that is taken as an indication that the auxiliary encoder was not able to encode the input data block in a lossless manner, and so the result of the auxiliary encoder 201 is reported as being that the input data block could not be losslessly compressed by the auxiliary encoder 200 (step 504).

On the other hand, in the case where all the bit planes were able to be encoded into the permitted maximum fixed size data packet (so that the auxiliary encoder was able to encode the input data block in a lossless manner), the forward 508 and reverse 509 bit streams and codec selection bit 510 are then combined (repacked) into a data packet 511 with a minimal gap 512 between the data streams (and accordingly (potentially) having a data size that is smaller than the permitted maximum fixed size data packet) (step 505).

The so “epacked” encoded (compressed) representation of the input data block is then output as the result of losslessly encoding the input data block using the auxiliary encoding scheme, together with an indication of the size of that encoded representation of the input data block (and, if necessary, additional information allowing the positions of the forward and reverse bit streams in the “repacked” representation to be determined (where that cannot otherwise be determined, e.g. from the size of the encoded data) (step 506).

Thus it can be seen that the result of attempting to encode an input data block using the auxiliary encoder 201 when attempting to losslessly encode an input data block will either be an indication that the auxiliary encoder was unable to encode the input data block in a lossless manner, or an encoded (and lossless) representation of the input data block, together with (at least) an indication of the size of that encoded representation of the input data block.

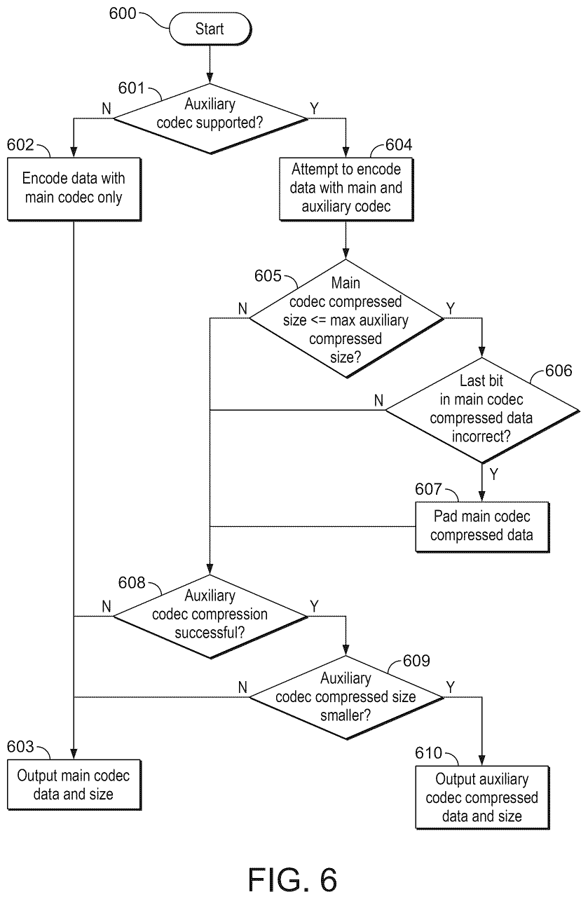

FIG. 6 shows a first embodiment of the operation of the encoding circuit 122 when encoding a data array (block) in a lossless manner.

As shown in FIG. 6, when a data array (block) is to be encoded losslessly (step 600), it is first determined whether the auxiliary encoder 201 supports encoding of a data array having the format in question (step 601).

In this regard, in the present embodiments, it is assumed that the auxiliary encoder 201 is configured to only be able to encode particular input data array (e.g. pixel) formats in a (potentially) lossless manner. This is so as to reduce the complexity of the auxiliary encoder 201. For other, not-supported, input data array (pixel) formats, only the main (lossless) encoder 200 will be used.

In the present embodiments, the control circuit 205 determines whether the input data array is of a format that is supported by the auxiliary encoder 201 or not (e.g., and in an embodiment, based on encoding state information that the control circuit 205 receives), and accordingly controls the encoding circuit 122 to either encode the input data array using the main (lossless) encoder 200 only, or to encode the input data array using both the main (lossless) encoder 200 and the auxiliary encoder 201.

As shown in FIG. 6, in the case where the input data array format is not supported by the auxiliary encoder 201, the overall input data array will simply be encoded (on a block by block basis) using the main (lossless) encoder 200 (step 602) (in the manner described above with reference to FIG. 4, for example).

Thus in this case, for each block of the overall input data array that has been encoded, the appropriate output from the main (lossless) encoder will be output as the result of encoding the input data block using the main (lossless) encoder 200, together with an indication of the size of the output data block (step 603).

As discussed above, in this case, for a given input block of an overall data array, the output result from the main (lossless) encoder 200 could be an encoded representation of the input data block, or the input data block in its original, uncompressed form.

As shown in FIG. 6, when, on the other hand, the format of the data array to be encoded is supported by the auxiliary encoder 201, the overall data array will then be (attempted to be) encoded (on a block by block basis) using both the main (lossless) encoder 200 and the auxiliary encoder 201 (step 604).

In this case, for each respective block of the overall input data array that is to be losslessly encoded, the block will be encoded using the main (lossless) encoder 200 in the manner shown above in FIG. 4, with a corresponding output result for the block from the main (lossless) encoder 200 accordingly being provided (and being either a compressed representation of the input data block or the input data block in its uncompressed form).

Correspondingly, the block will also be encoded using the auxiliary encoder 201, in the manner described above with reference to FIG. 5, with the result of the encoding of the block using the auxiliary (lossy) encoder 201 then either being an indication that the block could not be losslessly encoded by the auxiliary encoder, or a (lossless) encoded representation of the input data block that has been generated by the auxiliary encoder 201 (as discussed above with reference to FIG. 5).

Once a respective input data block has been (attempted to be) encoded by both the main (lossless) encoder 200 and the auxiliary encoder 201, the encoder selection unit 202 then operates to select which encoding result (i.e. whether the encoding result from the main (lossless) encoder 200 or the encoding result from the auxiliary encoder 201) should be used as the result (as the output representation) for the lossless encoding of the input block in question.

Steps 605 to 610 in FIG. 6 show this operation in the present embodiment.

As shown in FIG. 6, the encoder selection unit 202 first determines whether the size of the output block from the main (lossless) encoder 200 is less than or equal to the threshold maximum compressed size above which the auxiliary encoder “fails” to losslessly encode (compress) an input data block (step 605). This therefore has the effect of determining whether the output from the main (lossless) encoder 200 for the block of the overall data array could be equal to or smaller than the maximum size output from the auxiliary encoder 201 for the block of the overall data array.

In the case where it is determined that the output from the main (lossless) encoder 200 is less than or equal to the threshold maximum compressed size above which the auxiliary encoder “fails” to losslessly compress an input data block (so “yes” at step 605), the encoder selection unit 202 then determines whether the last bit in the encoded representation of the input data block has the appropriate value to indicate to a decoder that the encoded representation was generated using the main (lossless) encoder (step 606).

As discussed above, in the case of the auxiliary encoder 201, a bit value of “1” is included as the final “codec selection” bit in the output encoded block from that encoding scheme, so as to signify to a decoder that the block was encoded using the lossy encoding scheme.

Corresponding to this, the present embodiments use a last (final) bit value of “0” to indicate that an encoded representation of an input data block has been encoded using the main (lossless) encoding scheme. In the present embodiments, the main (lossless) encoder is configured to pad any unused bits at the end of an encoded representation of an input data block with 0's, so that in the normal course it may be expected that any output encoded block from the main (lossless) encoder 201 will more likely end with a “0” in any case.

However, the Applicants have recognised that there may be certain circumstances where an encoded block output from the main (lossless) encoder 200 is, e.g., exactly byte-aligned, and the last bit in that block is non-zero. In this case, a bit value of 0 may need to be added to the encoded block to allow a decoder to determine that the main (lossless) encoding scheme has been used for the encoded block. Step 606 therefore determines whether an additional “0” (or “0's”) need to be added to an encoded block output from the main (lossless) encoder for this purpose.

As shown in FIG. 6, in the case where the last bit in the encoded output block from the main (lossless) encoder has the correct value (i.e. “0” in the present embodiments), then that encoded block can be used “as is”.

On the other hand, where it is determined that the last bit has the incorrect value (i.e. in the present embodiments has a value of “1”), the encoder section unit 202 then operates to pad the output encoded block from the main (lossless) encoder with a byte of 0's at its end (step 607), so that that encoded block will now have the correct final bit having a value of 0 to allow the decoder to determine that the block was encoded using the main (lossless) encoding scheme.

This will then all have the effect of ensuring that where the output from the main (lossless) encoder was an encoded representation of the input data block that is (before any additional padding) smaller than or equal to the maximum losslessly compressed block size that the auxiliary encoder could produce for the block in question, that encoded representation will have a final bit value of “0” to thereby signify to a decoder that the encoded representation was generated using the main (lossless) encoding scheme.

The checking that the output from the main (lossless) encoder was an encoded representation of an input data block, and that it ends with the appropriate “0” value (or adding that value) could be performed elsewhere in the data encoder 122, for example, as part of the main (lossless) encoder operation, rather than by being performed by the encoder selection circuit 202, if desired.

As shown in FIG. 6, once the result of the lossless encoding scheme for the input data block has been identified and if necessary appropriately padded with 0's, the encoder selection unit 202 then determines whether the encoding of the input data block in question by the auxiliary encoder 201 was successful or not (i.e. whether the auxiliary encoder 201 was able to encode the input block in a lossless manner or not) (step 608). As discussed above, the auxiliary encoder 201 itself reports whether it was able to successfully encode an input data block in a lossless manner or not. The encoder selection unit 202 can simply use that report (where present) to determine whether the auxiliary encoding scheme was able to encode the block in a lossless manner or not.

As shown in FIG. 6, in the case where the auxiliary encoder (encoding scheme) was not able to encode the input data block in a lossless manner, then the encoder selection unit 202 simply outputs the result of the main (lossless) encoder 202 as the output result for the encoding for the input data block in question, together with the size of that main (lossless) encoder output (step 603).

As discussed above, this output may be an uncompressed version of the original input data block (which will then have a size corresponding to the uncompressed input data block), an encoded representation of the input data block with no padding (which will then have a size of the encoded representation of the input data block), or an encoded representation of the input data block padded with a byte of 0's (which will then have a size of the encoded representation of the input data block plus 1 byte).

As shown in FIG. 6, in the case where the auxiliary encoder 201 was able to encode the input data block in a lossless manner, it is then determined whether the resulting (lossless) encoded representation of the input data block is smaller than the output of the main (lossless) encoder 201 for the input data block in question (step 609) (which lossless encoder size may, as discussed above, be the size of the uncompressed input data block, a size of an encoded representation of the input data block, or a size of an encoded representation of the input data block plus 1 byte).

As shown in FIG. 6, in the case where the (lossless) encoded representation of the input data block generated by the auxiliary encoder 201 is not smaller than the output for the input data block from the main (lossless) encoder (encoding scheme), then again the output from the main (lossless) encoder 201 for the input data block in question, together with an indication of the size of that data block is output as the result of the encoding for the input data block in question (step 603).

On the other hand, where the auxiliary encoder generated a (lossless) encoded representation of the input data block having a smaller size than the output from the main (lossless) encoder for the data block in question, then the (lossless) encoded representation of the input data block generated by the auxiliary encoder 201 is used as the output result for the encoding for the input data block in question, so that encoded (compressed) data block, together with an indication of its (data) size (and, if necessary, additional information allowing the positions of the forward and reverse bit streams in the “repacked” representation to be determined), is output as the result of the encoding for the input data block in question (step 610).

The effect of all this will then be that the result of encoding an input data block using the auxiliary encoder 201 will be used as the result of the encoding of that data block in the case where the auxiliary encoding was able to encode the input block in a lossless manner and to a size that is smaller than the main (lossless) encoder (encoding scheme) was able to achieve. Otherwise, the result of the encoding from the main (lossless) encoder will be used.

This operation will be repeated for each block that an overall input data array has been divided into for encoding purposes.

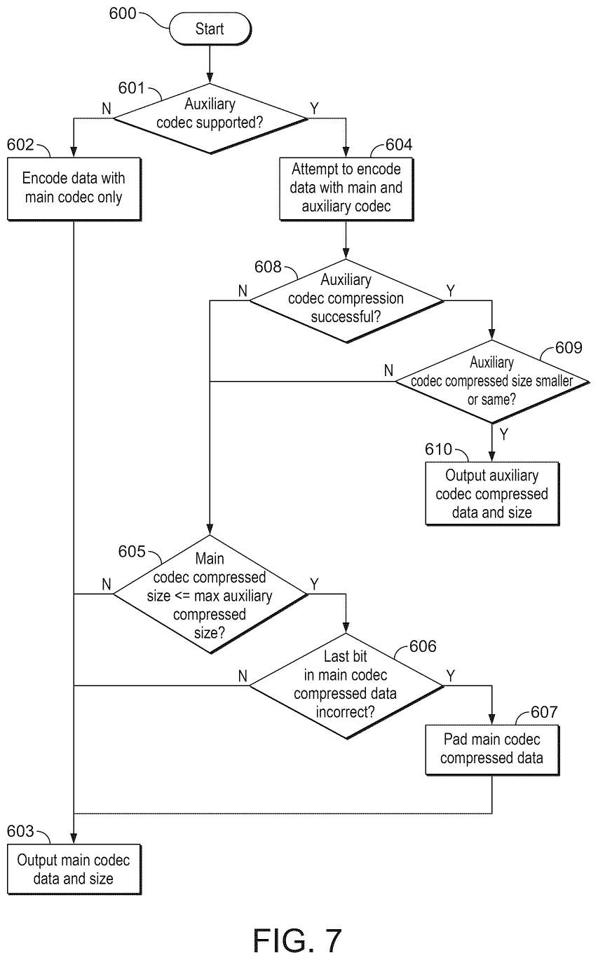

FIG. 7 shows an alternative embodiment for the operation of the encoder circuit 122 when encoding a data array in a lossless manner.

As can be seen from FIG. 7, this embodiment includes the same operations and steps as the embodiment shown in FIG. 6 (and accordingly those operations and steps will not be described again in detail with reference to FIG. 7), but as can be seen from FIG. 7, the order in which the operations are performed, in particular by the encoder selection unit 202, is changed.

In particular, in the embodiment shown in FIG. 7, the encoder selection unit 202 first operates to determine whether to use the result of encoding an input block with the auxiliary encoder 201 as the result of the lossless encoding of the input data block in question (steps 608, 609 and 610 in FIG. 7). (Only) in the case where it is determined that the encoding result from the auxiliary encoder 201 should not be used, does the encoder selection unit 202 then determine whether the result of the encoding using the main (lossless) encoder 200 needs to be padded with 0's or not (steps 605, 606 and 607 in FIG. 7), and then accordingly outputs the appropriate result of the encoding from the main lossless encoder 200 (step 603 in FIG. 7).

The above describes the encoding operation in the present embodiments.

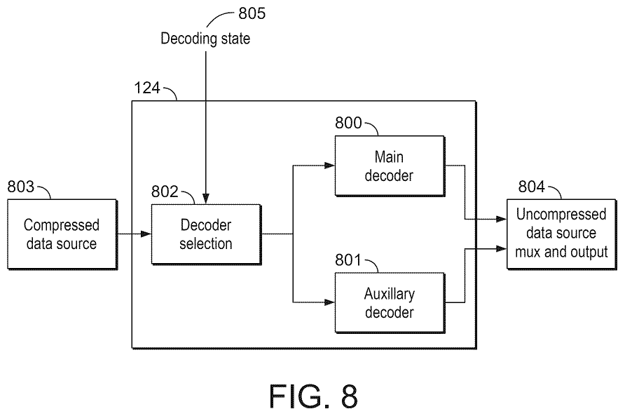

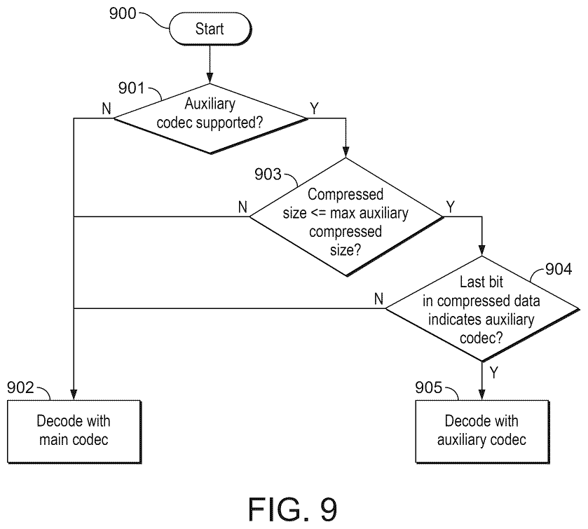

FIGS. 8 and 9 show the corresponding decoder circuit 124 and decoding operation, respectively.

FIG. 8 shows the decoder circuit 124 in the present embodiments in more detail.

As shown in FIG. 8, the decoder circuit 124 encodes both a main (lossless) decoder (decoding circuit) 800, and an auxiliary decoder (decoding circuit) 801, both of which are operable to decode compressed data 803 that has been encoded (compressed) in the manner of the present embodiments, to provide an uncompressed version 804 of the compressed (encoded) input data (and which will be an exact reproduction of the original input data that was compressed, as the input data will have been compressed losslessly and decompressed in a lossless manner).

The main (lossless) decoder 800 is accordingly configured to be able to losslessly decode data that has been encoded by the main (lossless) encoder 200. Correspondingly, the auxiliary decoder 801 is configured to be able to decode data that has been encoded by the auxiliary encoder 201.

The main (lossless) decoder 800 and the auxiliary decoder 801 are configured to decode respective encoded blocks of an overall data array to thereby provide respective decoded blocks of the data array.

As shown in FIG. 8, the decoder circuit 124 further comprises a decoder selection unit 802 that is operable to determine which of the main decoder 800 and the auxiliary decoder 801 should be used to decode a given “encoded” block of an overall data array that is to be decoded.

In particular, the decoder selection circuit 802 is configured to, and operable to, determine whether an “encoded” block for a data array should be decoded by the main decoder 800 or the auxiliary decoder 801 to provide the corresponding (losslessly) decoded version of the block of the overall data array.

The decoder selection unit 802 determines this based on, inter alia, an indication of the size of the block to be decoded and, where appropriate, the value of the final bit in the block to be decoded (i.e. whether it is a 0 or a 1, as discussed above for the encoding process).

As shown in FIG. 8, the decoder selection circuit 802 receives appropriate decoding state information 805 for a data array to be decoded, such as a data element (e.g. pixel) format for the data array to be decoded, and the block size (in terms of the number of data elements) that was used when the data array was being encoded, and any other known information would be useful for the decoding process to know/consider.

FIG. 9 shows an embodiment of the operation of the decoding circuit 124 when decoding an overall data array that has been encoded in a lossless manner in the manner of the present embodiments.

As shown in FIG. 9, when a data array is to be decoded (step 900), it is again first determined whether the auxiliary decoder 901 supports decoding of a data array having the format in question (step 901).

In the present embodiments, the decoder selection circuit 802 determines whether the overall data array to be decoded is of a format that is supported by the auxiliary decoder 801 or not (e.g., and in an embodiment, based on encoding state information 805 that the decoder selection circuit 802 receives).

As shown in FIG. 9, in the case where the format of the data array to be decoded is not supported by the auxiliary decoder 801, the data array will simply be decoded (on a block-by-block basis) using the main (lossless) decoder 800 (step 902).

Thus in this case, for each block of the overall data array to be decoded, the appropriate output from the main (lossless) decoder will be output as the result of decoding the input data block using the main (lossless) decoder 800 (step 902). In this regard, the main (lossless) decoder 800 will use the indicated size of a data block to be decoded to determine whether the block needs to be decoded or is simply the original data block in an unencoded (uncompressed) form, and provide an output “decoded” block accordingly.

As shown in FIG. 9, when, on the other hand, the format of the overall data array to be decoded is supported by the auxiliary decoder 801, the decoder selection unit 802 then determines whether the indicated (data) size of the block being decoded is less than or equal to the threshold maximum permitted data size for a block to be (potentially) encoded using the auxiliary compression scheme (as discussed above) (step 903). (As discussed above, in the embodiments discussed herein, the threshold maximum data size that is used for this test will be 46 bytes.)

This then has the effect that the decoding process (decoder selection circuit 802) can use the indicated size of a block to be decoded to straightforwardly identify whether the block could potentially have been encoded using the auxiliary encoding scheme or not, and in particular will simplify the decoder operation in this regard for unencoded (uncompressed) blocks.

As shown in FIG. 9, in the case where the indicated size of the block being decoded is greater than the threshold maximum permitted data size for a block to be (potentially) encoded using the auxiliary encoding scheme, the decoder selection unit 802 can accordingly determine that the block has not been encoded using the auxiliary encoding scheme and so it will cause the block to be decoded using the main (lossless) decoder 800 (step 902).

Thus in this case, the appropriate output from the main (lossless) decoder 800 will be output as the result of decoding the input data block (step 902).

On the other hand, as shown in FIG. 9, in the case where the indicated size of the block being decoded is less than or equal to the threshold maximum permitted data size for a block to be (potentially) encoded using the auxiliary encoding scheme (such that the block could have been encoded using either the auxiliary or the lossless (main) encoding scheme), it is then determined (the decoder selection unit 802 then determines) whether the last bit in the encoded data block to be decoded has the appropriate value to indicate that the encoded block was generated using the auxiliary encoding scheme or not (step 904). (As discussed above, in the present embodiments, in case of the auxiliary encoder 201, a bit value of “1” is included as the final “codec selection” bit in the output encoded block from that encoding scheme, so as to signify to the decoder that the block was encoded using the auxiliary encoding scheme (and corresponding to this, the present embodiments, if necessary, use a last (final) bit value of “0” to indicate that an encoded representation of an data block has been encoded using the main (lossless) encoding scheme).)

Based on the value of the last bit in the block being decoded, as shown in FIG. 9, the block being decoded is then decoded using the main (lossless) decoder 800 (step 902), or using the auxiliary decoder 801 (step 905), accordingly.

This operation will be repeated for each block of an overall data array to be decoded.

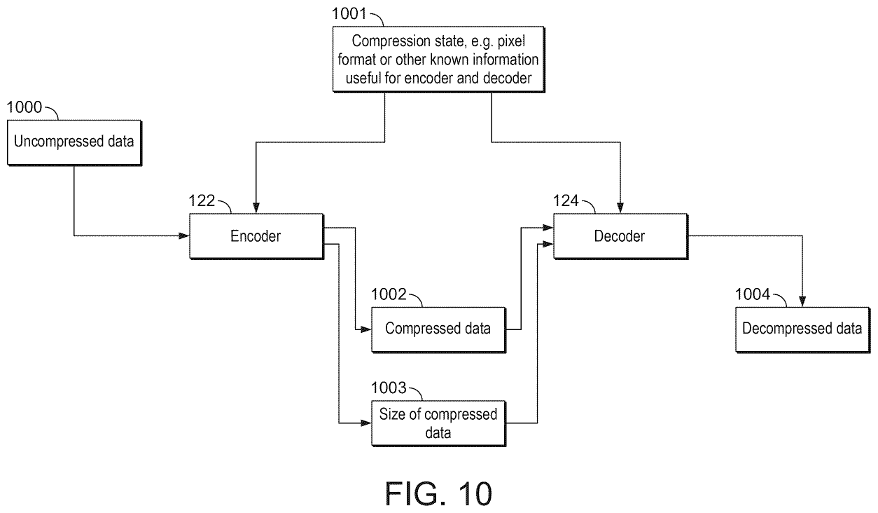

FIG. 10 shows the overall operation “flow” in the present embodiments.

As shown in FIG. 10, an uncompressed overall data array 1000 to be encoded will be provided to the encoding circuit 122 which encoding circuit will encode the array in a lossless manner using, inter alia, appropriate compression state information 1001 and provide as an output a set of “encoded” data blocks 1002, together with indications of the sizes 1003 of those data blocks.

The decoder 124 will then decode each of the “encoded” data blocks based on, inter alia, the indicated sizes of the data blocks and the compression state information 1001, to provide a lossless reconstruction 1004 of the original overall input data array 1000 that was encoded.

It will be appreciated from the above, that the technology described herein, in its embodiments at least, can provide more efficient and effective lossless encoding of data arrays. This is achieved, in the embodiments of the technology described herein at least, by when it is desired to encode a data array in a lossless manner, also attempting to encode the data array using an auxiliary encoding scheme (which can in certain circumstances at least encode in a lossless manner), and then selecting whether to use the output from the lossless encoding scheme or the auxiliary encoding scheme appropriately.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

What is claimed is:

1. A method of operating a data encoder that is capable of encoding arrays of data elements using two different encoding schemes, including a lossless encoding scheme that will encode data arrays in a lossless manner such that the original array of data elements can be reconstructed from the encoded data, and an auxiliary encoding scheme that can encode at least some data arrays in a lossless manner such that the original array of data elements can be reconstructed from the encoded data, the method comprising:
when it is desired to encode a data array in a lossless manner:
encoding the data array using the lossless encoding scheme, and
encoding the data array using the auxiliary encoding scheme; and
determining whether to use a result of the encoding of the data array using the auxiliary encoding scheme for the output encoded data array based on a result of encoding the data array using the auxiliary encoding scheme.

2. The method of claim 1, comprising, for each block of a plurality of blocks that an overall data array is divided into for encoding purposes:
encoding the block using the lossless encoding scheme; and
encoding the block using the auxiliary encoding scheme; and
determining whether to use a result of the encoding of the block using the auxiliary encoding scheme for the output encoded block of the overall data array based on a result of encoding the block using the auxiliary encoding scheme.

3. The method of claim 1, wherein encoding a data array using the lossless encoding scheme comprises determining whether the encoded version of the data array generated when applying the lossless encoding scheme to the input data array results in a data output that is larger than a threshold data size, and when the encoding of an input data array using the lossless encoding scheme results in an output data array that is larger than the threshold data size, providing the input data array in an unencoded form as the output of the lossless encoding scheme for the data array.

4. The method of claim 1, further comprising:
when it is desired to encode a data array in a lossless manner: determining, based on the data format of the data array to be encoded in a lossless manner, whether to encode the data array using the lossless encoding scheme and using the auxiliary encoding scheme, or to encode the data array only using the lossless encoding scheme.

5. The method of claim 1, wherein the determining whether to use the encoded representation of the input data array generated by the auxiliary encoding scheme is based on at least one of:
whether the auxiliary encoding scheme was able to encode the input data array in a lossless manner;
the size of a lossless encoded representation of the input data array generated by the auxiliary encoding scheme; and
the size of a lossless representation of the input data array generated by the lossless encoding scheme.

6. The method of claim 1, comprising:
determining whether the auxiliary encoding scheme was able to encode an input data array in a lossless manner by:
determining whether the auxiliary encoding scheme was able to losslessly encode the input data array within a permitted fixed maximum data size for encoding the array; and
when it is determined that the auxiliary encoding scheme was able to completely encode the input data array within the permitted maximum data size for encoding the data array, determining that the auxiliary encoding scheme was able to encode the input data array in a lossless manner.

7. The method of claim 1, further comprising:
including an indication of the encoding scheme that has been used for an encoded representation of a data array in the encoded representation of the data array.

8. A method of encoding a data array, the method comprising:
using an encoding scheme that can encode at least some data arrays in a lossless manner such that the original array of data elements can be perfectly reconstructed from the encoded data, to encode a data array, the encoding scheme includes:
encoding the input data array to a fixed sized data packet by generating two streams of encoded data, with one encoded data stream being stored starting from the beginning of the output fixed size data packet growing towards the end of the output fixed size data packet, and the other encoded data stream being stored starting at the end of the output fixed size data packet and growing towards the beginning of the output fixed size data packet;
the method further comprising:
when the encoding scheme is able to losslessly encode the data array into the fixed size data packet, repacking the two encoded data streams into a new data packet, and providing that new data packet as the output of the encoding scheme.

9. The method of claim 8, further comprising:
providing an indication that the encoding scheme was not able to encode the input data array in a lossless manner when the encoding scheme was not able to losslessly encode the data array into the fixed size data packet.

10. The method of claim 8, further comprising:
when the encoding scheme was able to losslessly encode the input data array into the fixed size data packet, outputting an indication of the size of the new data packet after the repacking of the data streams, and including a bit having a value that indicates that the encoding scheme has been used in the generated encoded representation of the input data array that is produced by the encoding scheme.

11. An apparatus for encoding data, comprising:
an encoding circuit configured to encode an array of data elements using a lossless encoding scheme that will encode data arrays in a lossless manner such that the original array of data elements can be reconstructed from the encoded data; and
an auxiliary encoding circuit configured to encode an array of data elements using an encoding scheme that can encode at least some data arrays in a lossless manner such that the original array of data elements can be reconstructed from the encoded data;
the apparatus further comprising a processing circuit configured to:
when it is desired to encode a data array in a lossless manner:
cause the data array to be encoded using the lossless encoding scheme, and to be encoded using the auxiliary encoding scheme; and
determine whether to use a result of the encoding of the data array using the auxiliary encoding scheme for the output encoded data array based on a result of encoding the data array using the auxiliary encoding scheme.

12. The apparatus of claim 11, wherein the processing circuit is configured to, when it is desired to encode an overall data array in a lossless manner:
cause each block of a plurality of blocks that the overall data array is divided into for encoding purposes to be encoded using the lossless encoding scheme, and to be encoded using the auxiliary encoding scheme;
and to:
determine for the block whether to use the result of the encoding of the block using the auxiliary encoding scheme for the output encoded block of the overall data array based on a result of encoding the block using the auxiliary encoding scheme.

13. The apparatus of claim 11, wherein the encoding circuit configured to encode a data array using a lossless encoding scheme is configured to:
determine whether the encoded version of the data array generated when applying the lossless encoding scheme to the input data array results in a data output that is larger than a threshold data size; and
when the encoding of an input data array using the lossless encoding scheme results in an output data array that is larger than the threshold data size, provide the input data array in an unencoded form as the output of the lossless encoding scheme for the data array.

14. The apparatus of claim 11, comprising a processing circuit configured to, when it is desired to encode a data array in a lossless manner:
determine, based on the data format of the data array to be encoded in a lossless manner, whether to encode the data array using the lossless encoding scheme and using the auxiliary encoding scheme, or to encode the data array only using the lossless encoding scheme.

15. The apparatus of claim 11, wherein the processing circuit is configured to determine whether to use the encoded representation of the input data array generated by the auxiliary encoding scheme based on at least one of:
whether the auxiliary encoding scheme was able to encode the input data array in a lossless manner;
the size of a lossless encoded representation of the input data array generated by the auxiliary encoding scheme; and
the size of a lossless representation of the input data array generated by the lossless encoding scheme.

16. The apparatus of claim 11, comprising a processing circuit configured to:
determine whether the auxiliary encoding scheme was able to encode an input data array in a lossless manner by:
determining whether the auxiliary encoding scheme was able to losslessly encode the input data array within a permitted fixed maximum data size for encoding the array; and
when it is determined that the auxiliary encoding scheme was able to completely encode the input data array within the permitted maximum data size for encoding the data array, determining that the auxiliary encoding scheme was able to encode the input data array in a lossless manner.

17. The apparatus of claim 11, wherein the encoding circuits are configured to:
include an indication of the encoding scheme that has been used for an encoded representation of a data array in the encoded representation of the data array.

18. An apparatus for decoding encoded data, comprising:
a decoding circuit configured to decode data that has been encoded using a lossless encoding scheme that will encode a data array in a lossless manner such that the original array of data elements can be reconstructed from the encoded data; and
a decoding circuit configured to decode data that has been encoded using an auxiliary encoding scheme that can encode at least some data arrays in a lossless manner such that the original array of data elements can be reconstructed from the encoded data;
the apparatus further comprising:
a processing circuit configured to, when it is desired to decode a data array that has been encoded in a lossless manner:
determine whether the data array should be decoded using the lossless decoding scheme or using the auxiliary decoding scheme; and
cause the data array to be decoded using the determined decoding scheme.

19. The apparatus of claim 18, wherein the processing circuit is configured to:
determine whether an encoded block representing part of an overall encoded data array to be decoded should be decoded using the lossless decoding scheme or using the auxiliary decoding scheme; and
cause the block to be decoded using the determined decoding scheme.

20. The apparatus of claim 18, wherein the processing circuit is configured to determine whether to decode a data array using the lossless decoding scheme or using the auxiliary decoding scheme based on at least one of:
the size of the encoded data array to be decoded; and
an indication in the encoded data array to be decoded of the encoding scheme that has been used for encoding the data array.
